(19) United States
(12) Patent Application Publication
(10) Pub. No.: US 2002/0104288 A1
(43) Pub. Date: Aug. 8, 2002

(54) Panel with two-dimensional curvature

(76) Inventors: Donald Q. O'Sullivan, Cambridge, MA (US); Alexander H. Slocum, Bow, NH (US)

Correspondence Address: DALY, CROWLEY & MOFFORD, LLP, SUITE 101, 275 TURNPIKE STREET, CANTON, MA, 02021-2310, US

(21) Appl. No.: 09/940,078

(22) Filed: Aug. 27, 2001

Related U.S. Application Data
(60) Provisional application No. 60/227,957, filed on Aug. 25, 2000.

(51) Int. Cl. E04C 2/00; E04C 2/54; E04F 13/00; E04F 15/00; E04F 19/00; E04C 1/00; B44F 7/00; B44F 9/00

(52) U.S. Cl. 52/782.1; 52/311.1; 52/316

(57) ABSTRACT

A panel having a panel topology and a mode-shaped panel are provided each having pre-defined bending strength characteristics, vibration characteristics and acoustic characteristics improved from those of a flat panel. A panel having both panel topology and a mode shape is provided having further improvements. A panel having a multi-layered structure is provided having at least one layer that has either a mode shape or a panel topology, and other layers that may be flat or curved and that may be damping layers.

### RELATED APPLICATIONS

This application claims the benefit of U.S. Provisional Application No. 60/227,957, filed on Aug. 25, 2000 which application is hereby incorporated herein by reference in its entirety.

### GOVERNMENT RIGHTS

Not Applicable.

### FIELD OF THE INVENTION

This invention relates generally to structural panels and more particularly to panels that have a panel topology and/or a mode shape that provides improved structural characteristics.

### BACKGROUND OF THE INVENTION

As is known in the art, a panel is a structure which can be described by geometric boundaries. For example, a panel having a rectangular shape is provided having a length, L, a width, W, and a thickness T, which typically is at least an order of magnitude less than both the panel length and width. Panels are known to have a variety of shapes. Some of the most common panel shapes include flat panels, corrugated panels, ribbed panels, and dimpled panels. Such panels can be used in a variety of applications. Flat panels, for example, can provide enclosures for appliances and machines. Panels molded into specific shapes can be used as vehicle body panels. Panels can also be used in construction applications (i.e. construction panels), to provide floors, walls, and of roofs buildings. It should be recognized that a conventional flat panel, in many applications, provides insufficient strength, vibration dampening, and acoustic absorption properties.

Corrugated panels most often have a sinusoidal surface shape which provides the panel having a bending strength which is improved relative to a flat panel. Thus, the conventional corrugated panel can provide a strength increase in one direction with respect to a corresponding flat panel of like dimensions without a substantial weight increase.

The bending strength of a corrugated panel is enhanced only along the one direction of the curves thereby leading to an orthotropic panel, where orthotropic is defined as varying with respect to direction. Other conventional panels also have one-dimensional curvature, including cylindrical panels that are used for items such as cans, where the curved shape is primarily ergonomic.

In acoustic applications, it can be very detrimental to have a highly orthotropic panel design due to the increased frequency range over which one encounters critical frequencies. The increased range of critical frequencies can lead to lessened transmission loss and noisier enclosures. Critical frequency will be described below.

Conventional panels can be also be provided having layers, where one or more layers at the center of the multi-layered panel structure are either generally flat or corrugated, and layers at the outside surfaces of the panel are generally flat. For example, plywood is a conventional multi-layered panel structure where all layers are flat. A single flat layer of wood has a weaker bending strength in one direction, along the wood grain. However, plywood has several flat wood layers glued together with the wood grain running in orthogonal directions to provide bending strength that is more isotropic, where isotropic is defined as invariant with respect to direction. For another example, some panels have a corrugated central layer for strength in one direction, and flat layers as outer panel surfaces attached to the corrugated layer. This type of construction is typical, for example, in the construction of panels used in cardboard boxes.

Conventional multi-layered panel structures can also be provided for vibrational dampening and acoustic absorption. For example, flat layers of hard material alternating with layers of soft material, can provide a dampening effect. Alternatively, harder central panel layers can be corrugated, ribbed, or folded, alternating with layers of soft material.

It should be recognized that conventional flat panels provide structures that have low strength, low vibration dampening, and low acoustic absorption properties. It should further be recognized that conventional panels with one-dimensional curvature, for example corrugated panels, have improved strength in only one direction. It should further be recognized that panels with one-dimensional curvature, for example corrugated panels, have improved strength in one direction only.

It would therefore be desirable to provide a panel having increased bending strength compared to a corresponding flat panel of the dimensions. It would also be desirable to provide a panel having selectable bending strength characteristics, for example, isotropic bending strength. It would be further desirable to provide a panel having selectable vibration dampening and acoustic characteristics.

### SUMMARY OF THE INVENTION

A panel is provided having a two-dimensional shape defined by an intersecting plane, a surface of the panel, and a nominal plane. The nominal plane is a plane passing through a surface point of the panel and is generally orthogonal to a principal loading direction of the panel at the surface point. The intersecting plane is a plane generally orthogonal to the nominal plane. An intersection of the intersecting plane with the surface of the panel at the surface point is a line having a peak to trough value. The peak to trough value, when normalized by dividing by the thickness of the panel, typically falls within the range of 2 to 40.

The above panel has two-dimensional curvature that can provide either a mode-shaped panel, a panel with a panel topology, or a panel with both a mode shape and with panel topology.

A method of designing a panel having a panel topology that provides a pre-determined bending strength comprises, generating a panel topology defined as indicated above, defining the panel surface with panel topology parameters, and determining panel metrics associated with the panel performance. The panel design is further optimized though an optimization function to which the panel metrics can be applied, and in association with which the panel topology parameters are adjusted.

A method of designing a mode-shaped panel having a mode shape selected to provide a pre-determined response to acoustic signals and vibrational forces comprises, modeling a flat panel to determine the vibrational mode shapes and frequencies of the flat panel, adjusting the flat panel model to incorporate mode shape parameters that provide the mode-shaped panel, re-modeling the mode-shaped panel to determine the new frequencies and amplitudes of vibration, and adjusting the mode shape parameters to provide the pre-determined response to acoustic signals and vibrational forces.

With this particular arrangement, a panel with panel topology is provided having a bending strength with pre-determined directional characteristics. Often the design requirement is to provide a panel with a generally uniform bending strength in all bending directions, whereby the panel is generally isotropic, and to provide a panels with a bending strength that is improved from that of a corresponding flat panel. The panel with panel topology also provides improved vibration and acoustic performance.

Also with this particular arrangement, a mode-shaped panel is provided having reduced vibration and acoustic transmission and reflection. In particular, a mode-shaped panel that is mode-shaped to match the shape of a natural mode of vibration of a corresponding un-deformed panel provides reduced vibration at the natural mode to which the shape corresponds. The mode-shaped panel also provides improved bending strength.

Also with this particular arrangement, a multi-layered panel structure is provided having multiple layers, each layer either having a panel topology, a mode shape, or a flat shape, and where some layers may be made of a damping and/or acoustic absorption material. A panel structure with this arrangement provides performance improvements relative to a single layer panel and relative to a multi-layered panel structure composed of only flat or corrugated layers.

### BRIEF DESCRIPTION OF THE DRAWINGS

The foregoing features of the invention, as well as the invention itself may be more fully understood from the following detailed description of the drawings, in which:

FIG. 1A is an isometric view of a panel with two-dimensional curvature;

FIG. 1B is another isometric view of a panel with two-dimensional curvature;

FIG. 1C is yet another isometric view of a pane with two-dimensional curvature;

FIG. 2 is an isometric view of a surface of an illustrative mode-shaped panel with the shape of the first mode of vibration of a corresponding un-deformed panel;

FIG. 3 is an isometric view of a surface of an illustrative mode-shaped panel with the shape of the fourth mode of vibration of a corresponding un-deformed panel;

FIG. 4 is an isometric view of a flat panel;

FIG. 5 is an isometric view of a shallow spherical shell;

FIG. 6A is another isometric view of a shallow spherical shell;

FIG. 6B is a portion of a cross section of the shallow spherical shell of FIG. 6;

FIG. 7 is a flow diagram of the processes used to provide a mode-shaped panel;

FIG. 8 is a graph showing the shift in frequency for the modes of vibration for a mode-shaped panel shaped as the first mode of vibration of a corresponding un-deformed panel, as the normalized amplitude of the shape increases

FIG. 9 is an isometric pictorial showing the resulting first eight modes of vibration for a mode-shaped panel shaped as the first mode of vibration of a corresponding un-deformed panel;

FIG. 10 is an isometric pictorial showing the resulting first eight modes of vibration for a mode-shaped panel shaped as the fourth mode of vibration of a corresponding un-deformed panel;

FIG. 11 is an isometric view of the surface of a panel with an illustrative statistical panel topology corresponding to a random panel topology;

FIG. 12 is an isometric view of the surface of a panel with another illustrative statistical panel topology corresponding to another random panel topology;

FIG. 13 is a flow diagram of the process used to provide a panel with panel topology;

FIG. 14 is an isometric view of the surface of a panel with yet another statistical panel topology corresponding to an illustrative maze panel topology;

FIG. 15 is an isometric view of the surface of a panel with a yet another statistical panel topology corresponding to yet another maze panel topology;

FIG. 16 is an isometric view of the surface of a panel with a yet another statistical panel topology corresponding to yet another maze panel topology;

FIG. 17 is a flow diagram of the process used to generate a statistical panel topology;

FIG. 18 is an isometric view of the surface of a panel with an illustrative two-dimensional sinusoid panel topology;

FIG. 19 is an isometric view of the surface of a panel with another illustrative two-dimensional sinusoid panel topology;

FIG. 20 is an isometric view of the surface of a panel with yet another illustrative two-dimensional sinusoid panel topology;

FIG. 21 is a flow diagram of the process used to generate a shape based panel topology;

FIG. 22 is a diagram of a three ellipse shape used to define a shape based panel topology and more particularly an elliptical panel topology;

FIG. 23 is an isometric view of the surface of a panel with a shape based panel topology provided by the illustrative shape of FIG. 22;

FIG. 24 is a flow diagram of the process used to generate a two-dimensional sinusoid panel topology;

FIG. 25 is a top view of a single tile used to provide an illustrative tile panel topology;

FIG. 26 is an isometric view of a panel having an illustrative tile panel topology, provided by the illustrative tiles of FIG. 25;

FIG. 27 is a flow diagram of the process used to generate a tile panel topology;

FIG. 28 is an isometric view of a panel having a two-dimensional corrugated panel topology corresponding to an illustrative concentric circle panel topology;

FIG. 29 is an isometric view of a panel having another illustrative two-dimensional corrugated panel topology corresponding to an illustrative flower petal panel topology;

FIG. 30 is an isometric view of a panel having yet another illustrative two-dimensional corrugated panel topology corresponding to an illustrative zigzag panel topology;

FIG. 31 is a flow diagram of the process used to generate a two-dimensional corrugated panel topology;

FIG. 32 is a graph showing the bending strength of eighty cross sections parallel to a first edge of illustrative panels having maze, two-dimensional sinusoid, tile, and zigzag surface topologies;

FIG. 33 is a graph showing the bending strength of one hundred twenty cross sections parallel to a second edge orthogonal to the first edge of the illustrative panels of FIG. 32;

FIG. 34 is a three dimensional graph showing the bending strength along many cross sections of the illustrative panel of FIGS. 27 and 28 having a two-dimensional sinusoid panel topology;

FIG. 35 is a three dimensional graph showing the bending strength along many cross sections of the illustrative panel of FIGS. 27 and 28 having a tile panel topology;

FIG. 36 is a three dimensional graph showing the bending strength along many cross sections of the illustrative panel of FIGS. 27 and 28 having a maze panel topology;

FIG. 37 is a three dimensional graph showing the bending strength along many cross sections of the illustrative panel of FIGS. 27 and 28 having a zigzag panel topology;

FIG. 38 is a graph showing the shift in frequency for the modes of vibration of a panel with two-dimensional sinusoid panel topology as the normalized amplitude of the shape increases;

FIG. 39 is a cross section of a multi-layered panel structure having a two-dimensionally curved panel portion and a flat layer portion;

FIG. 40 is a cross section of a multi-layered panel structure having a two-dimensionally curved panel portion and two flat layer portions;

FIG. 41 is a cross section of a multi-layered panel structure having a two-dimensionally curved panel portion, two flat layer portions, and two damping layer portions;

FIG. 42 is a cross section of a multi-layered panel structure having a two-dimensionally curved panel portion, two flat layer portions, one or each of which has flat multi-layer panel portions, and two damping layer portions;

FIG. 43 is a cross section of a multi-layered panel structure having a two-dimensionally curved panel portion, a flat layer portion, a damping layer portion, and a constrained damping layer portion;

FIG. 44 is a cross section of a multi-layered panel structure having two two-dimensionally curved panel portion, two damping layer portions, and a constrained damping layer portion; and

FIG. 45 is a cross section of a multi-layered panel structure having three two-dimensionally curved panel portion, and two damping layer portions.

### DETAILED DESCRIPTION

Before describing panels in accordance with the present invention, some introductory concepts and terminology are explained. In a Cartesian coordinate system having mutually perpendicular axes x, y, and z, a surface is defined by a plane formed from the intersection of any two axes (i.e. the x-y axes define the x-y plane and the y-z axes define the y-z plane), where the defining axes are along the major dimensions of the surface. In general, a panel is an object having a surface and a thickness and for which the dimensions of the surface (i.e. length and width) are at least ten times larger than the dimension of the thickness. For example, a panel having a surface defined by the x-y plane would have dimensions in the x and y directions which are both at least ten times larger than the dimension in the z direction line (e.g. the panel width and length would be ten times greater than the panel thickness). Variables can be used to describe the shape of a panel surface. The terms one-dimensional versus two-dimensional curvature will be used herein when referring to surfaces. A flat panel lying in he x-y plane can be described by a panel surface for which z=C, where C is a constant. A panel lying in the x-y plane and having a surface with a one-dimensional curvature can be described by a panel surface for which z=f(x) or equivalently by z=f(y). A panel lying in the x-y plane and having a surface with a two-dimensional curvature can be described by a panel surface for which z=f(x,y). Thus, a surface with one-dimensional curvature has curvature that propagates in one direction only, for example in direction x or y. Examples of one-dimensional curvature include a cylinder and a corrugated panel. Two-dimensional curvature has curvature that propagates in two directions, x and y. Examples of two-dimensional curvature include a simple dome. The curvature does not need to be continuous or smooth and therefore may contain sharp corners, perforations, holes, and varied boundaries.

The term “panel topology” will be used herein to refer to features on a surface of a panel which vary in height. In the above example in which the panel lies in the x-y plane, this corresponds to a variation in the z direction by functions z=f(x), or z=f(y), or z=f(x,y), where z varies along the indicated x or y dimensions rapidly, i.e. on a dimensional scale much less than the maximums of dimensions x and y.

The term “mode shape” will be used herein to describe a panel having a predefined shape corresponding to the shape of one of the modes of vibration the undeformed panel can take in response to a force.

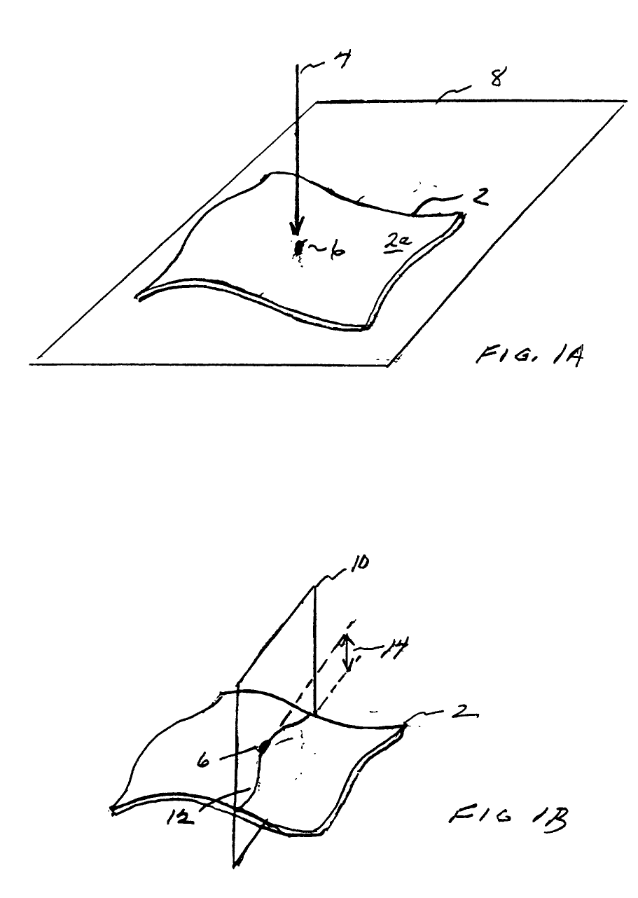

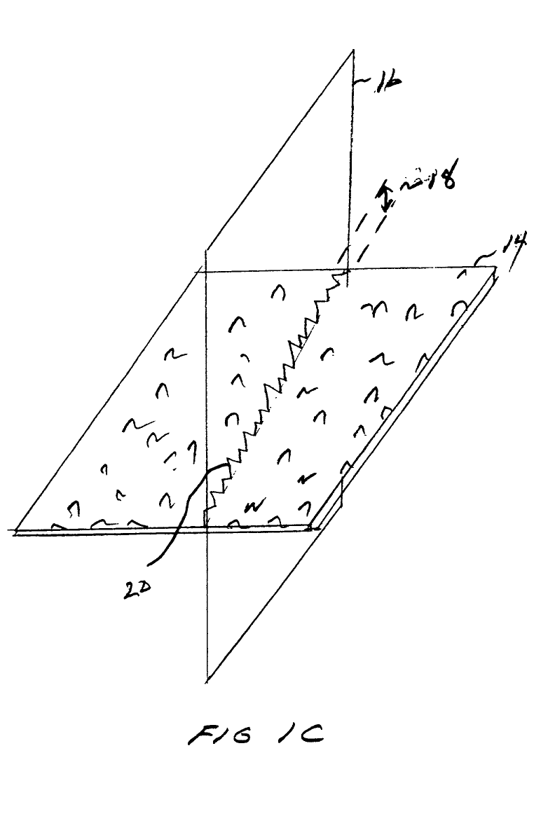

The term “amplitude” or “peak-to-trough value” as used herein will refer to the amount of deviation on a surface of a panel lying in the x-y plane in the z direction provided by either the panel topology or the mode shape. Thus, a panel said to have a relatively high amplitude refers to a panel having a shape that greatly departs from being flat. Both terms will correspond to a position on the surface where the amplitude, or peak to trough value, is a maximum. The term “normalized amplitude” or “normalized peak to trough value” as used herein will be used to describe either the amplitude or the peak to trough value divided by the thickness of the panel. Amplitude will be further described in FIG. 1A.

All of the terms, one-dimensional curvature, two-dimensional curvature, panel topology, and mode-shaped as used herein refer to either surfaces of panels or to panels. Unless otherwise noted, where the terms refer to panel is assumed that both of the panel surfaces have complimentary shape, defined herein to mean that each such surface is curved to provide a panel having generally constant thickness at each point on the panel surface. In some applications, it may be desirable to provide a panel having both a mode-shaped and a panel topology.

Referring now to FIGS. 1A, and 1B in which like elements are provided having like reference designations, a panel 2 having a surface 2a with a two-dimensional curvature is shown. As will be described below in the conjunction with FIGS. 1A and 1B, panels provided in accordance with the present invention are provided having a characteristic such that a nominal plane of the panel at any point is orthogonal to a principal loading direction of the panel at that point and any plane that intersects the nominal plane will intersect the panel in a non-straight line having a peak-to-trough value which is about 2-100 times the panel thickness. In preferred embodiments, the peak-to-trough value is in the range of about 4 to about 40 times the panel thickness.

A principal load force represented as reference numeral 4 in FIG. 1A, either bending or vibration, with a principal loading direction is applied at a panel surface point 6. A nominal plane 8 intersects the panel at panel surface point 6. The nominal plane is disposed such that it is generally perpendicular to the principal loading direction 4. An intersecting plane 10 (FIG. 1B), generally perpendicular to the nominal plane 8, intersects the surface of the panel 2 at the surface point 6. The variation of the height of the surface 2A is represented by a curve 12. An amplitude of the surface 2A is represented by reference lines 14. An amplitude 14 (un-normalized) defines the curvature of the line 12.

Panel topology and panel mode shape can both be generally defined by the intersecting plane, the surface of the panel, and the nominal plane. A panel having a panel topology or a mode shape is one where the intersection 12 of the intersecting plane 10 with either surface of the panel 2 is a line 12 that is not straight and that has a peak to trough value 14, or generally an amplitude, where such value is greater than zero. A variety of mode-shaped panels and panels with panel topology will be described below. However, it should be recognized that there are a large number of mode-shaped surface and surface topologies that can be provided and that fit the above generalized description. Note also that though the term “curvature” will be used herein throughout, the intersecting line can have sharp corners.

The amplitude 14 may be different for different panel surface points. It should be recognized that the term amplitude, or peak to trough value, as used herein, unless otherwise stated, is the maximum amplitude, or peak to trough value, that can be found at an intersection 12 at any panel surface point 6 on the surface of the panel 2.

Referring now to FIG. 1C, a panel 14 with a statistical panel topology is intersected by intersecting plane 16, defined as in FIG. 1B. Line 18 represents an amplitude (un-normalized) which defines the curvature of the intersecting line 20. Whereas FIG. 1B most closely resembles an illustrative mode-shaped panel, FIG. 1C most closely resembles an illustrative panel having a panel topology provided in accordance with the present invention.

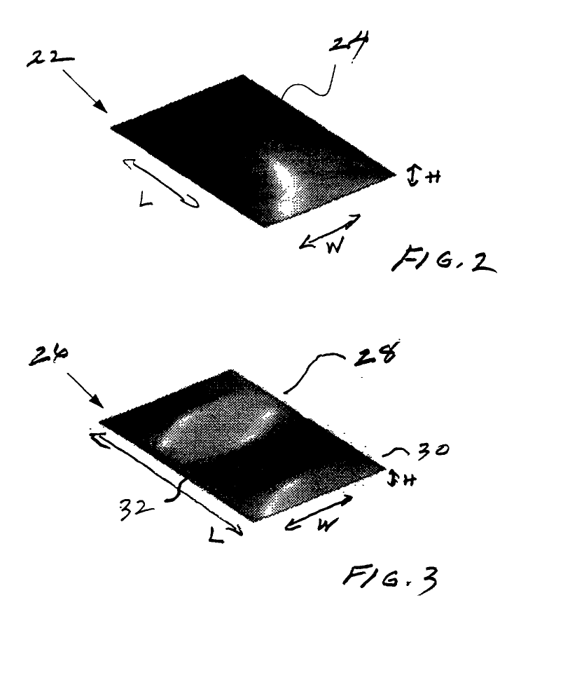

Referring now to FIG. 2, the surface 22 of a panel having a length L, a width W and a thickness H is provided having an illustrative mode shape corresponding to the first mode of vibration of a corresponding un-deformed panel having the same length, width and thickness. In this particular instance, the mode shape corresponds to a general dome shape 24. Thus, the panel is formed plastically into a shape corresponding to the shape of the first mode of vibration that would occur if the panel, with the same material and dimensional characteristics, were un-deformed, for example flat, and. For this particular panel having the length L, width W, and thickness H, and clamped boundary conditions, the first mode of vibration corresponds to the shape of a dome.

Now referring to FIG. 3, the surface 26 of an illustrative mode-shaped panel, shaped as the fourth mode of vibration, has a shape with two peaks 28, 30 and a trough 32. As above, the panel is formed plastically into a shape corresponding the shape of the fourth mode of vibration of a corresponding un-deformed panel having length L, width W, thickness H and clamped boundary conditions. It should be recognized that, for this illustrative panel, the fourth mode of vibration is the second odd mode.

In general, the first few vibrational modes of a flat panel are the most detrimental because they have the largest displacements. Additionally, the odd modes of vibration of a flat panel are the most undesirable because the odd number of peaks versus valleys produces non-canceling acoustic noise.

In accordance with the present invention, however, by pre-forming or otherwise providing the panel having a shape corresponding to one of the vibrational mode shapes, particularly the shape of the first mode, which the panel would normally take in response to vibrational or other forces, the panel is provided having a pre-determined and reduced response to vibration and a reduction in acoustic noise transmission. Thus, in accordance with the present invention, a mode-shaped panel is provided having a shape corresponding to the shape of an undesired mode shape of vibration where the mode shape is determined from a corresponding un-deformed panel.

In a preferred embodiment, the panel is provided having a shape corresponding to the most undesired mode shape of vibration. If the normalized amplitude of the mode shape is sufficiently large then that mode shape should not occur in the subsequent vibration behavior of the resulting mode-shaped panel at the original mode frequency that corresponds to the un-deformed panel. If the mode shape does occur under vibration, it will occur at a higher frequency, often outside of the frequency range of concern.

In general, the vibrational mode corresponding to the shape of a mode-shaped panel cannot occur in bending. However, the mode of vibration represented by its mode shape can occur due to tension/compression forces. It is known by one of ordinary skill in the art that tension/compression forces provide a higher energy behavior than bending force for a panel-like structure. Consequently, a vibration mode which occurs due to tension/compression forces is at a higher frequency and at a lower displacement and surface velocity that that vibration mode when it occurs due to bending forces.

A panel having a two-dimensional curvature has greater stiffness than a corresponding un-deformed panel. A panel with two-dimensional curvature can be represented as a doubly curved shell. One of ordinary skill in the art will recognize that curved shells are typically provided having a stiffness characteristic which is greater than the stiffness characteristic of a flat structure, especially at low frequencies. Increased stiffness is provided in part because the curved shell structure supports much of the load via tension/compression forces rather than only in bending force. Thus, a panel provided having a mode shape provides both a stiffer panel and a panel that vibrates with lessened displacement and velocity.

Acoustic transmission is known by one of ordinary skill in the art to represent the fraction of sound that, upon impinging upon a panel surface, passes through the panel and into the air adjacent to the other surface. Acoustic transmission of a panel is strongly related to a critical frequency of the panel. The critical frequency is a frequency at which sound waves impinging on the panel at an angle perpendicular to the surface of the panel has a propagation velocity through the air that matches the propagation through the panel. Acoustic transmission through the panel is often maximum at the critical frequency. A panel generally has a critical frequency substantially higher than frequencies of the lower order modes of vibration. Providing a panel having a shape corresponding to the shape of a lower order mode, with corresponding low order curvature, does not dramatically alter the critical frequency of the panel. At higher vibrational frequencies where the critical frequency is encountered, the bending deformation wavelengths that coincide with the acoustic waves are small enough that the strain energy of the mode shapes are dominated by bending deformation, and strain due to tension/compression is less significant.

As will be further described below, where a panel is pre-deformed into a mode shape, the resulting mode-shaped panel is likely to have resulting vibrational modes that are less undesirable or less efficient at radiating noise than a corresponding un-deformed panel. However, the mode-shaped panel may have new resulting modes of vibration that are also undesirable. A mode-shaped panel can only reduce the likelihood of one particular mode of vibration from occurring. However, one of ordinary skill in the art will recognize that the first mode of vibration of a flat panel often dominates the undesirable vibration characteristics of the panel. Thus, the first mode of vibration is often the desired shape in which to form a mode-shaped panel, thus eliminating this vibrational mode.

In one embodiment, the mode shaped panels are provided having a normalized peak-to-peak amplitude typically in the range of about 2 to about 40 in which the mode-shaped panel provides optimal vibration behavior. The performance within this range is shown in simulation results below.

To better understand the above, it is helpful to look at the mechanics of several curved systems. It may first be useful to consider a curved beam with respect to curvature effects mechanics.

The most commonly analyzed curved beams are those with circular curvature, also referred to as circular arcs. Although circular curvature does not accurately describe the geometry of a mode-shaped design, it is similar and provides a useful comparison. A thin beam in particular has a thickness that is much smaller than the radius of curvature of the arc so that shear deformation and rotary inertia can be neglected in the analysis of such a structure. Furthermore, the thin beam is assumed to have rectangular cross-section, essentially a slice of a shell, so that the flexural and torsional dynamics are not internally coupled. Also, only two modes of vibration must be considered, longitudinal (stretching or tension/compression) and in-plane flexural (bending) vibration. Out of plane flexural vibrations are not a relevant factor in panels. It will be recognized that in plane-bending is bending in the plane of the arc, and out of plane bending is any other bending direction.

Longitudinal, or tension/compression, modes are those modes where the primary deflections are due to tension and/or compression of the beam along the axis of the beam, where the axis is a curved line passing through the center of the beam. Flexural, or bending, modes are dominated by transverse displacement, transverse to the axis of the beam. It will be recognized by one of ordinary skill in the art that, for circular arcs, the longitudinal modes have much higher natural frequencies than flexural modes.

It will also be recognized by one of ordinary skill in the art that the curvature of the arc couples the flexural and longitudinal modes. It will be further recognized that if the ends of the arc are clamped, then the beam cannot support the first in-plane flexural mode. Furthermore, other lower order odd modes of flexural vibration are strongly affected and shifted to higher frequencies by the curvature and clamped ends, while even mode flexural vibrations can still form. This phenomenon has important acoustic ramifications. It can be inferred that the odd shaped modes will be shifted to significantly higher frequencies due to a greater degree of coupling from the odd flexural modes to corresponding longitudinal modes. This shifting of the odd modes to significantly higher frequencies is likely to lead to a reduction of the acoustic radiation over the frequency range of interest.

A simple example of the above coupling of modes is apparent in structural arches. It will be recognized by one of ordinary skill in the art that an arched doorway is able to support greater loads because the forces are supported primarily in compression, where the stiffness can be approximated by

$${k}_{c} ≅ \frac{EA}{L}$$

in which E is Young's Modulus, A is the cross-sectional area of the structure and I is the second moment of inertia. It will be further recognized that a flat topped doorway can support less of a force because the load is supported in bending, where the stiffness (at the center) can be approximated by

$${k}_{b} ≅ \frac{384 EI}{5 {L}^{3}} .$$

Where k_{c}, k_{b} are the stiffness of the arch and the flat beam respectively, E is young's modulus, A is the cross-sectional area of the structure, I is the second moment of inertia, and L is the length of the beam transverse to the cross section. Where the length to thickness ratio is great, the stiffness of the arch is much greater.

One of ordinary skill in the art will also recognize the general analysis of doubly curved shells. Analysis of doubly curved shells provides further understanding of the behavior of mode-shaped panels. By plastically deforming a flat panel into one of its mode shapes, one creates a type of doubly curved shell that has shape characteristics similar to a mode shape, for example the mode shape of FIG. 2.

Similar to a thin curved beam, a thin curved shell provides an increase in stiffness due to the shifting from flexural, or bending, to longitudinal, or tension/compression, deformation. Due to the coupling between bending and tension/compression deformation, a thin curved shell cannot support bending deformation alone. In general, under deformation, for example under bending vibration, greater shell curvature provides a greater proportion of deformation that is coupled from a bending to a corresponding tension/compression mode. As will be recognized by one of ordinary skill in the art, the shift from bending to tension/compression deformation of a thin curved shell leads to an increase in transverse stiffness, stiffness perpendicular to the plane defined by the shell boundaries, because the tension/compression of a thin object requires greater energy than bending.

It is possible to make a comparison between the modes of vibration of a panel in bending and a panel in pure tension/compression. As was discussed previously, to have a mode-shaped panel deform further into the mode shape in which it is designed, primarily deform longitudinally, i.e. it stretches, rather than in bending (assuming clamped boundaries and a panel shape normalized amplitude sufficiently large). Under these conditions a panel deforms much like a membrane, for which there is accurate theory and equations of motion.

A membrane is a panel-like or shell-like structure that can only resist deformation in tension/compression. It will be recognized by one of ordinary skill in the art that the natural frequencies for a rectangular membrane, a thin panel-like structure, are approximated by:

$${f}_{i , n} = \frac{1}{2} \sqrt{\frac{Eh}{m A} [ \frac{{i}^{2}}{{a}^{2}} + \frac{{n}^{2}}{{b}^{2}} ]} ( Hz ) i , n = 1 , 2 , 3 ,$$

where m is the surface density, E is the modulus of elasticity, h is the panel thickness, a and b are the length and width of the panel, A is the panel area (i.e. A=a b), and i and n correspond to the number of nodal lines plus one in the a and b directions, or likewise the number of flexural half-waves in a particular direction. The lowest frequency mode corresponds to i=n=1. A comparison can be made between the natural frequencies of a panel in bending versus a panel in pure tension/compression for the same approximate mode shape. It will be recognized by one of ordinary skill in the art that a comparison factor, x, can be defined as follows:

f_{bending}=x·f_{stretching}

then x can be determined to be:

$$𝒳 = \frac{π h}{a} \sqrt{\frac{( {i}^{2} + {{n}^{2} ( \frac{a}{b} )}^{2} )}{12 ( 1 - {v}^{2} )}}$$

where a, b, I and n are as defined above and v represents Poisson's ratio. From this it is evident that a panel in pure tension/compression, for thin panel geometries where h<<a, has modes of vibration that occur at much higher frequencies than a panel in pure bending. In particular, a panel with a mode shape corresponding to the fundamental mode of vibration, has a natural frequency in tension/compression that is at least two orders of magnitude greater than its natural frequency in bending.

The comparison factor, x, increases as the thickness of the panel decreases or as the area of the panel increases. Therefore, although the mode-shaped panel can deform further into the shape in which it is designed, such further deformation occurs largely in tension/compression, and thus at significantly higher frequencies with reduced displacement and velocity.

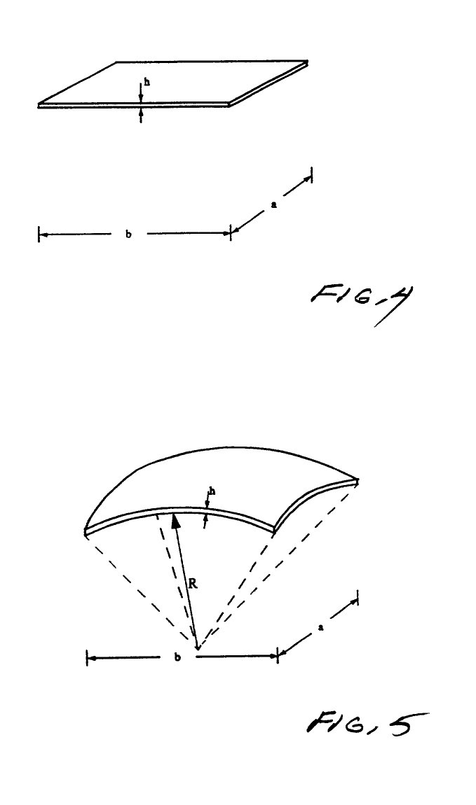

Referring now to FIGS. 4 and 5, FIG. 4 is an isometric view of a flat panel having a length b, a width a, and a thickness h, while FIG. 5 is a spherical section of a panel with the same dimensions a, b and h. A spherical section is a shallow spherical shell. A shallow spherical shell is characterized as one that has an amplitude more than an order of magnitude less than the smallest characteristic length, where the characteristic length is a distance describing the length of an edge, or a diameter.

It will be recognized by one of ordinary skill in the art that there is a mathematical relationship between the natural frequency, or preferred bending mode, of a flat plate and of a shallow spherical shell with the same thickness, boundary conditions and geometry, and material properties. The natural frequencies have been shown to be related by the following formula:

$${ω}_{shell} = \sqrt{{ω}_{plate}^{2} + \frac{E}{ρ {R}^{2}}}$$

where ωₛₕₑₗₗ is the natural frequency of the spherical shell (in radians), ωₚₗₐₜₑ is the natural frequency of the flat plate, E is the elastic modulus, ρ is the material density, and R is the radius of curvature of the shallow spherical shell. It is evident that the shallow spherical shell has a higher natural frequency than the flat panel and thus a higher stiffness. The natural frequency is also a strong function of R, the radius of curvature of the shell.

It should be noted that a shallow spherical shell, having a small normalized amplitude by definition, has similar mode shapes in vibration to those of a flat panel. Therefore, a shallow spherical shell is not likely to provide the same beneficial acoustic result as a mode-shaped panel, having greater normalized amplitude. The relationship between mode-shaped panel performance and normalized amplitude is further described in FIG. 8.

The above equation for a shallow spherical shell can be used as an initial approximation for the natural frequencies of a mode-shaped panel design. As a first approximation, one can assume that the mode shape design has a spherical cross-section whose curvature is determined by

$$κ = \frac{1}{R} = \frac{2 H}{{( \frac{b}{2} )}^{2} + {H}^{2}}$$

where κ denotes curvature, H is the height or amplitude of the panel curvature, and b is the length of the longest side of the panel. Note that this spherical shape assumption is only valid for a spherical shape, yet is similar to the shape of a mode-shaped panel shaped as the first mode.

The acoustic transmission of a mode-shaped panel is strongly related to the critical frequency and coincidence of the panel, where the coincidence is known to occur at frequencies above the critical frequency and for angles of acoustic incidence other than perpendicular. In general, when one stiffens a panel, one decreases the critical frequency and thus increases the range of coincidence, often causing greater structural acoustic coupling. One of the benefits of the mode-shaped design is that it should not significantly decrease the critical frequency from that of a corresponding un-deformed panel. The critical frequency is not increased because at the higher frequencies and shorter wavelengths, in the range of the coincidence frequencies, the stiffness increase is much less than at lower frequencies. One of ordinary skill in the art will recognize that the height to chord length of the curvature decreases as one looks at smaller scales, and at smaller scales the section begins to resemble and behave more like a flat panel. When one reaches the wavelength range corresponding to the range of coincidence, the bending wave behavior of the mode-shaped designs is very near that of a flat panel (assuming L>>h, where L is the characteristic wavelength and h is the panel thickness).

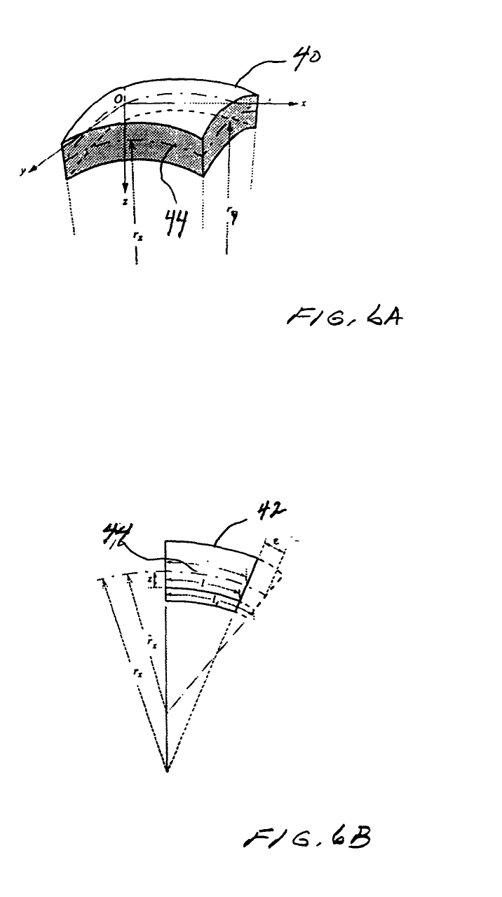

Referring now to FIGS. 6A and 6B, in which like elements are provided having like reference designations, FIG. 6A shows an isometric view of a shell 40 having a two-dimensional curvature and FIG. 6B shows a cross section 42 of a piece of a panel. The two-dimensionally curved panel 40 with thickness h has a radius of curvature rₓ and r_{y} in the x-z and y-z planes respectively. Strain, ε, is shown in the plane of the cross section. It should be recognized that there is a strain in tension/compression in the orthogonal plane that is not shown.

It will be recognized by one of ordinary skill in the art that one can mathematically analyze a shell with two-dimensional curvature. By looking at the strain contributions from both bending and longitudinal deformation one can gain a qualitative understanding of the mechanics the shell with two-dimensional curvature for various vibration conditions. It will be recognized that the strain contributions can be shown to be:

$${ϵ}_{{b}_{x}} = \frac{z}{1 - \frac{z}{{r}_{x}}} ( \frac{1}{{\tilde{r}}_{x}} - \frac{1}{{r}_{x}} ) , {ϵ}_{{b}_{y}} = - \frac{z}{1 - \frac{z}{{r}_{y}}} ( \frac{1}{{\tilde{r}}_{y}} - \frac{1}{{r}_{y}} )$$

$${ϵ}_{{s}_{x}} = {ϵ}_{1} , {ϵ}_{{s}_{y}} = {ϵ}_{2}$$

where ε_{bx}, and ε_{by}, are the strains due to bending in the x and y directions respectively, εₛₓ and ε_{sy}, the strains due to tension/compression deformation at the mid-surface in the x and y directions respectively, z is the direction orthogonal to the x-y plane, rₓ and r_{y} are the radii of curvature in the x and y planes respectively of the shell without vibrational deformation, and \tilde{r}ₓ and \tilde{r}_{y} are the radii of the shell element after deformation. The total strain is thus:

$${ϵ}_{x} = \frac{{l}_{{d}_{x}} - {l}_{x}}{{l}_{x}} = \frac{{ϵ}_{1}}{1 - \frac{z}{{r}_{x}}} - \frac{z}{1 - \frac{z}{{r}_{x}}} ( \frac{1}{{\tilde{r}}_{x} ( 1 - {ϵ}_{1} )} - \frac{1}{{r}_{x}} ) , \\ {ϵ}_{y} = \frac{{l}_{{d}_{y}} - {l}_{y}}{{l}_{y}} = \frac{{ϵ}_{2}}{1 - \frac{z}{{r}_{y}}} - \frac{z}{1 - \frac{z}{{r}_{y}}} ( \frac{1}{{\tilde{r}}_{y} ( 1 - {ϵ}_{2} )} - \frac{1}{{r}_{y}} )$$

where lₓ and l_{y} are the un-deformed length of the shell element at a distance z from the mid-surface 44, and l_{dx} and l_{dy} are the deformed length of the shell element at a distance z from the mid-surface 44. Some simplifications can be made since the shell is assumed be thin (i.e. h<<rₓ, r_{y}), specifically 1−z/rₓ≅1−z/r_{y}≅1. It will be further recognized by one of ordinary skill in the art that it can be further assumed that the tension/compression deformation has a effect on the curvature of the element (i.e. 1−ε₁≅1−ε₂≅1). Thus, the equations above simplify to:

$${ϵ}_{x} = {ϵ}_{1} - z ( \frac{1}{{\tilde{r}}_{x}} - \frac{1}{{r}_{x}} ) = {ϵ}_{1} - z ( Δ {κ}_{x} ) , \\ {ϵ}_{y} = {ϵ}_{2} - z ( \frac{1}{{\tilde{r}}_{y}} - \frac{1}{{r}_{y}} ) = {ϵ}_{2} - z ( Δ {κ}_{y} )$$

where Δκₓ and Δκ_{y} represent the changes in curvature due to bending.

From these equations several qualitative statements can be made concerning the strain energy contribution due to bending vs. tension/compression deformation. At lower order bending modes, i.e. at modes with bending curvature on the order of the curvature of the shell, the change in curvature, Δκₓ and Δκ_{y}, is less significant and the total strain energy is more likely to be dominated by tension/compression strains. At higher order bending modes, i.e. modes with bending curvature radii much smaller than the bending radii rₓ, r_{y} of the shell, the total strain energy is more likely to be dominated by strains due to bending. With regard to vibration, this implies that the higher order bending modes a of curved panels, such as the mode-shaped panel, are not significantly effected by the curvature of the panel, however, the lower order bending modes are significantly effected. Furthermore, with regard to acoustic transmission, the critical frequency of a mode-shaped panel, which occurs near frequencies of higher order bending modes, is not significantly effected, (i.e. reduced), thus the acoustic transmission is neither improved nor worsened at these higher frequencies.

It will be recognized by one of ordinary skill in the art that yet another way to analyze a mode-shaped panel is through ring frequency behavior. The ring frequency is generally associated with cylinders or pipes and is used to describe the deformation characteristics of those systems. Below the ring frequency the bending wave response is dominated by the curvature of the shell, and above the ring frequency the shell behaves more like a flat panel, with little increase in stiffness due the curvature of the shell. Although the formula for ring frequency is based on a cylinder, it can be generalized to any thin curved shell as follows:

$${f}_{r} = \frac{{c}_{L}}{2 π r} = \frac{\sqrt{\frac{E}{ρ ( 1 - {v}^{2} )}}}{2 π r}$$

where c_{L} represents the longitudinal bending wave speed, E is the material modulus, ρ is the density, v is Poisson's ratio, and r represents the radius of curvature of the shell. To ensure a good design, the ring frequency should be as high as possible but well below the critical frequency of the panel. By ensuring that the ring frequency is below the critical frequency, one can ensure that the range of coincidence is not increased by the curvature of the panel.

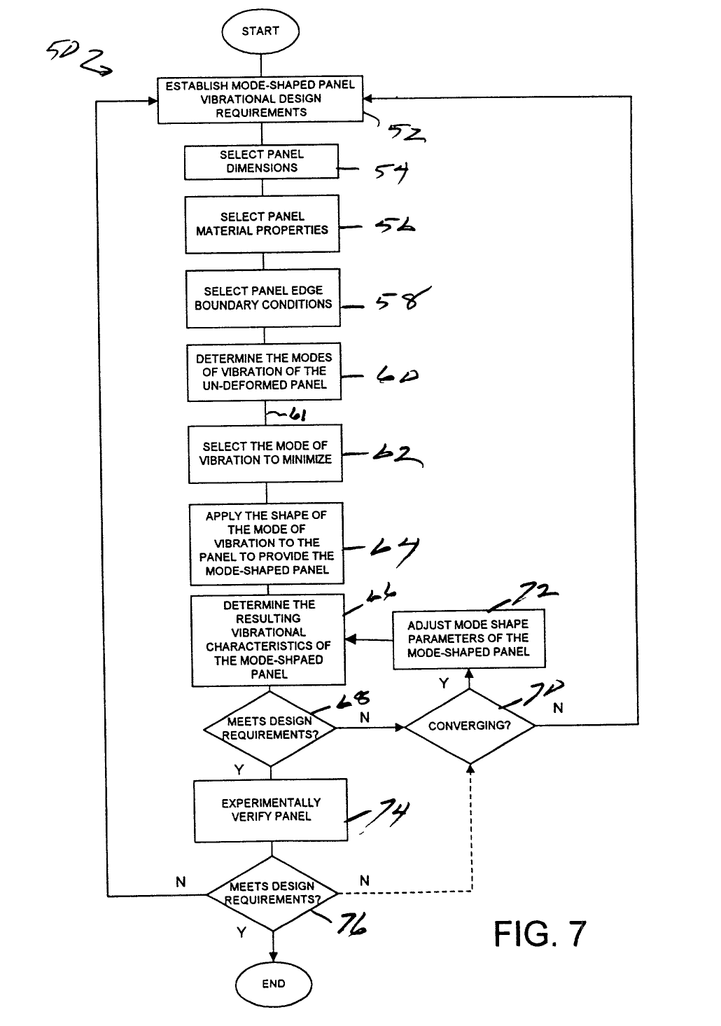

Referring now to FIG. 7, a method 50 of providing a panel with a mode shape begins by establishing vibrational design requirements at step 52. In general, each particular application in which a panel is used will have different vibrational requirements. For example, a panel used as a washing machine enclosure will have certain vibrational requirements, while a panel used as a wall may have different vibrational requirements. Where the washing machine panel will undergo particular vibrational excitation, for example at 5 Hz from the spinning drum of the washing machine, the wall panel will undergo other vibrational excitation, for example 1 Hz from human footsteps nearby. Thus, the design requirements may be different for different applications.

The designer, beginning with an un-deformed panel, selects panel dimensions at step 54, panel material properties at step 56, and panel boundary conditions at step 58. The particular dimensions, properties and boundary conditions depend upon the particular application in which the panel will be used. These characteristics are combined at step 60 to determine, for example with a mechanical model, the modes of vibration of the un-deformed panel at any frequency and in particular to provide the natural modes of vibration.

The panel modes of vibration are determined at step 60, using any technique well known to those of ordinary skill in the art, including but not limited to finite element analysis techniques and modeling. However, it will be recognized by one of ordinary skill in the art that other methods can be used to provide the modes of vibration. For example, empirical mathematical methods can be used to predict the modes of vibration. Additionally, experimental methods can directly provide the mode shapes of the panel.

At step 62, an undesirable mode of vibration is selected from among the modes that were provided as a result of step 60. As described above, the particular undesirable vibrational mode of concern is specific to the panel and the application of the panel. Thus, at step 62, the designer considers the modes of vibration of the panel as provided by the model and considers the application and the vibrational excitation under which the panel will be used.

Again using the above example of a washing machine flat panel, when analyzed the washing machine panel may show a natural mode of vibration at 5 Hz. Knowing that the panel will undergo vibrational excitation at 5 Hz, the designer attempts to reduce the 5 Hz mode of vibration of the panel.

At step 64, the shape of the undesired mode of vibration is applied to the panel to provide a mode-shaped panel, corresponding to a plastic deformation of the previously un-deformed panel model. At step 66 the new vibrational performance of the mode-shaped panel mode-shaped panel is determined by methods discussed above in association with step 60. At step 68, the designer examines the performance determined at step 66 and if the panel does not meet the design criteria of step 52, the designer alters one or more panel parameters as shown at step 70. For example, the normalized amplitude of the mode shape or the specific curvature of the mode shape can be altered. Once the mode-shape parameters of the panel are adjusted, processing returns to step 66 where the resulting vibrational characteristics of the mode-shaped panel are again determined. This loop is repeated until a panel having desirable characteristics is found. The loop convergence to a design that meets the design requirements is analyzed at step 70 at each pass through the loop. If the panel behavior at step 70 is found not to be converging with panel adjustments at step 72 to a solution that meets the design requirements, then the process is stopped and new design requirements must be established at step 52.

It is determined that the mode-shaped panel fits the design requirements at step 68, the panels are experimentally verified at step 74. Whereas the determined behavior of the mode-shaped panel at step 66 is only an approximation, the actual panel may behave differently at step 74. If the panel experimentally meets the design requirements at step 76, the process is complete. If the panel does not experimentally meet the design requirements at step 76, optionally the panel again is altered again as above at step 72 and the panel is re-modeled at step 66. Alternatively, the process must begin again at step 52 with new design requirements.

If panel parameters cannot be found which result in a panel which meets design requirements, it may be necessary to start the process at an earlier step, for example step 54 with new panel characteristics, including panel size, panel material properties, and panel boundary conditions. Alternatively, it may be necessary to start from the beginning of the process at step 52 and establish new vibrational requirements.

Referring now to FIG. 8, output data is shown that is derived at step 68 of the process described in FIG. 7 for a mode-shaped panel that is shaped into the first mode of vibration. The normalized amplitude of the panel, or equivalently the normalized peak to trough value, is indicated along the x axis, and a normalized frequency is indicated along the y axis. The normalized frequency is the frequency of a particular natural mode of vibration in the mode-shaped panel, for example mode one, divided by the frequency of the first mode of vibration if the panel were flat. Looking at the curve 80 representing the first mode of vibration of the mode-shaped panel, one can see that its intersection 78 with the Y axis is at 1. This intersection is as expected since at this point, the normalized amplitude of the panel mode shape is zero, thus the panel is flat, and the frequency of its first mode of vibration will be that of a flat panel. Each curve 80-94 represents a change in the frequency of a particular respective mode of vibration, therein are shown modes one through eight, as the normalized amplitude of the panel shape is increased. All curves 80-94 are representative of a panel that is pre-deformed into the shape of a first mode of vibration.

Again referring to the curve 80 that represents the first mode of vibration of the first mode-shaped panel, it can be seen that for a normalized amplitude of two, represented by data point 96, the first mode of vibration has a frequency that is approximately 1.6 times the frequency of the first mode if it were a flat panel, represented by data point 78. Similarly, a normalized amplitude of fifteen, represented by data point 98, provides a normalized frequency of vibration of the first mode that is nearly seven times that of the first mode if it were a flat panel, represented by data point 78.

The frequencies of the other modes of vibration of the mode-shaped panel can be seen to be similarly effected, though the panel is shaped only as the first mode of vibration. Modes two through eight, represented by curves 82-94 respectively, show that for a normalized amplitude of fifteen, the normalized frequency of each mode has moved substantially higher than the mode if the panel were flat. For example, it can be seen that for a flat panel, the normalized frequency of the eighth mode of vibration is approximately 4.6 times the first mode, as represented by data point 102. As the amplitude of the mode-shaped panel, shaped to the first mode only, is increased to fifteen, the normalized frequency of the eighth mode becomes approximately twice that of the eight mode of a flat panel, represented by data point 104. Thus, the eighth mode has increased in frequency by a factor of approximately two, even though the panel is shaped only to the first mode of vibration. It can be similarly seen that though the normalized frequency of vibration of the first mode is most strongly effected by the mode shape, the normalized frequency of higher modes are also effected, to a progressively lesser degree.

It can be seen that the curves 80-94 begin to flatten toward zero slope as the normalized amplitude is increased. Thus, there is a highest bound of normalized amplitude above which no significant further benefit will be derived. The upper bound has been found to be approximately 40 for this particular example. It can be seen that there is a lower bound of normalized amplitude below which there is no significant benefit. A lower bound of approximately 2 can be inferred for this particular example. Thus, the preferred bounds of normalized amplitude for this particular example are from 2 to 40.

Though preferred normalized amplitude bounds of from 2 to 40 have been determined for this particular example, the useful bound may be different for mode-shaped panels that are shaped to other modes of vibration. It should also be recognized that the curves 80-84 correspond to an illustrative panel with particular length, width, thickness, and material properties. Other panels provide similar, but different, curves.

Harmful vibration is generally reduced by increasing the natural frequencies of vibration (equivalent to stiffening) because the amount of dynamic deflection and the velocity of that deflection is reduced during vibration as compared to a flat panel under similar excitation. Reduced deflection and velocity of movement can often reduce unwanted vibrational effects.

Although the amplitude/thickness ratio, or normalized amplitude, is here shown to be in the range of about 0 to about 15, a desirable range is 2 to 100, a more desirable range is 2 to 40 and a further desirable range is 5 to 40. It should, however be recognized that the preferred range of normalized amplitude varies with the panel length, width, thickness, and material properties.

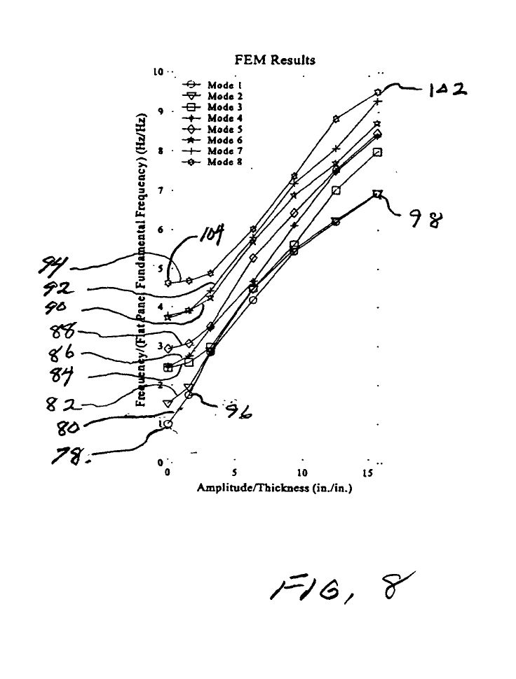

Referring now to FIG. 9, the first eight modes of vibration 106a-106h are shown in topographical form for a mode-shaped panel preformed to the first mode of vibration, as determined for an un-deformed panel. In these representations 106a-106h, the normalized amplitude is approximately ten. Normalized frequency values 108a-108h associated with each mode of vibration 106a-106h indicate the resulting normalized frequency. Thus, the first mode normalized frequency is 9.33 (increased from 1.0) and the eighth mode normalized frequency is 13.9.

Referring now to FIG. 10, the first eight modes of vibration 110-110h are shown in topographical form for a mode-shaped panel shaped to the fourth mode of vibration, as determined for an un-deformed panel. In these representations 110a-110h, the normalized amplitude is ten. Normalized frequency values 112a-112h associated with each mode of vibration 110a-110h indicate the resulting normalized frequency. Thus, the first mode normalized frequency is 5.94 (increased from 1.0) and the eighth mode normalized frequency is 18.4. Compared to FIG. 9, it can be seen that lower order modes, below the fourth mode, as less significantly effected. For example, the first mode of vibration 110a has increased by a to a normalized frequency of 5.94 as opposed to 9.33 for a panel shaped as the first mode 106a. It can also be seen that the higher order modes of vibration are more significantly effected than the mode-shaped panel shaped as the first mode, represented by FIGS. 9-9G. For example the eighth mode of vibration 11-h has increased to a normalized frequency of 18.4 as opposed to 13.9 for a panel shaped as the first mode 106h.

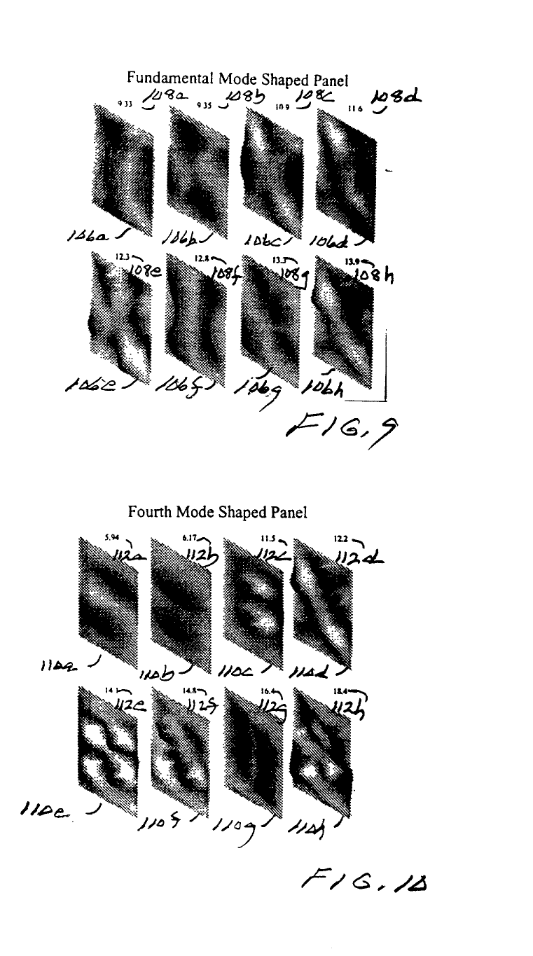

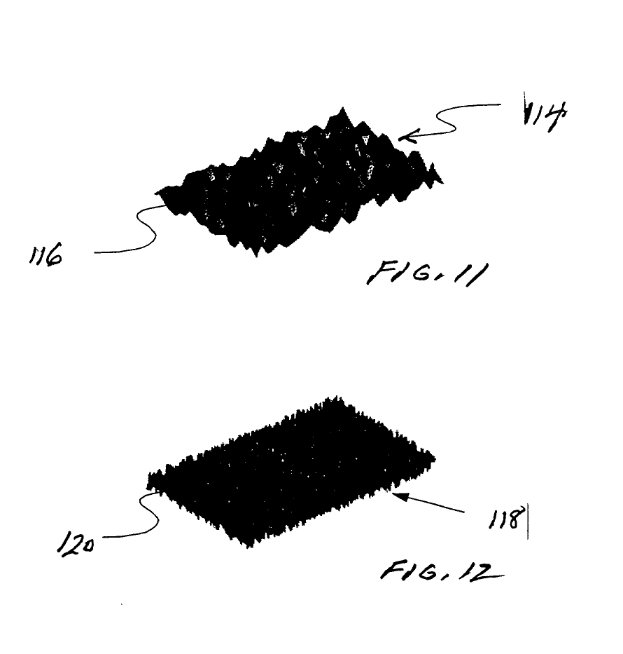

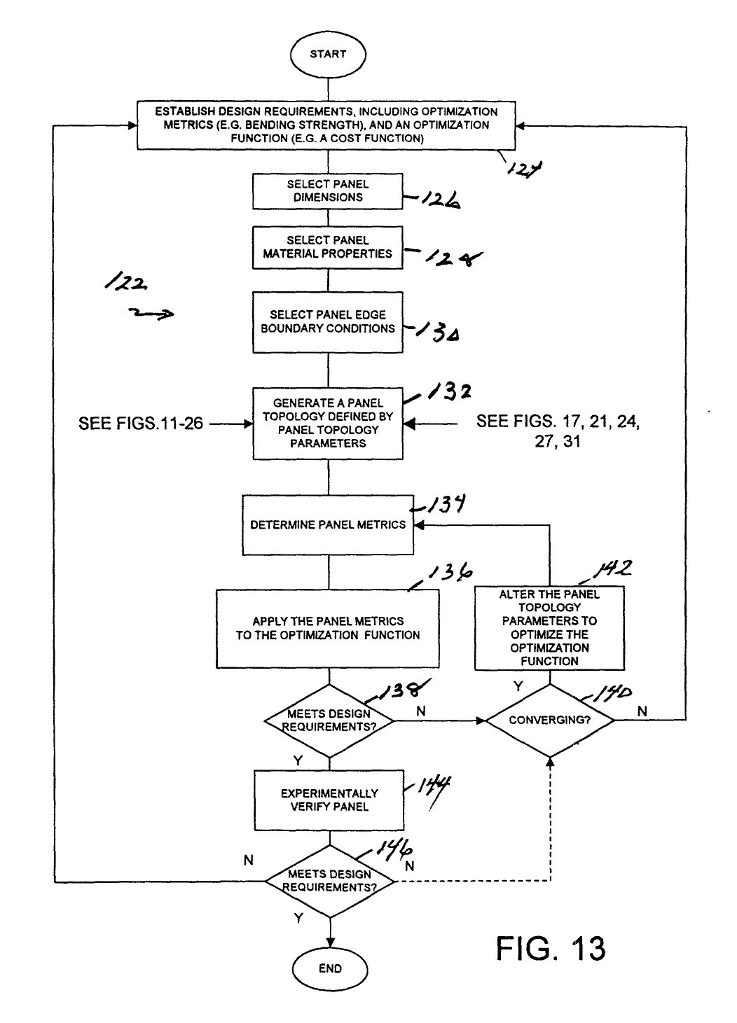

Referring now to FIG. 11, an isometric view of a panel surface 114 having a statistical panel topology 116 corresponding to a random panel topology is shown. Panel topology provides characteristics with different emphasis from those of the mode-shaped panels previously described. As has been described, the mode-shaped panel provides primarily a reduction of particular modes of vibration, and secondarily an increase in panel stiffness. The mode-shaped panel generally provides a panel design to satisfy a vibrational and acoustic design requirement. In contrast, a panel having a panel topology provided in accordance with the present invention, is provided having primarily an increase in panel stiffness, or bending strength, with a secondary effect on the modes of vibration. The panel with panel topology generally provides a panel design to satisfy a bending strength requirement. Most notably, a panel with two-dimensional panel topology in accordance with this invention can provide a bending strength improvement that is nearly isotropic throughout the x-y plane of the panel, or alternatively has a particular desired non-isotropy.

Whereas the random panel topology 116 provides a particular statistical panel topology, it will become clear from subsequent FIGS. 11-26 that there are a variety of two-dimensional surface topologies that may be used. It will be shown in the process of FIG. 13 that a panel with each such surface can be characterized so as to optimize certain panel metrics.

Referring now to FIG. 12, an isometric view of the surface of a panel 118 with yet another statistical panel topology 120 corresponding to yet another random panel topology is shown. Comparing this surface to that of FIG. 11, the surfaces are described by the same quantitative model, but the panel topology parameters have been altered, including the number of points to which a random amplitude can be assigned and the resolution of the points, to provide a surface with smaller features than those of the previous figure.

Referring now to FIG. 13, a method for providing a panel having a panel topology begins with step 124 in which design requirements are established. Such design requirements include determination of the type of optimization metrics that are required, the type of optimization function to which the metrics will be applied, as well as the specific value to be obtained from the optimization function.

One important aspect of determining an optimal two-dimensional panel topology is defining metrics by which the designs are evaluated, and the optimization function to which the metrics are applied. For example, such metrics can include the bending strengths along various axes of the panel, and they may be applied to an optimization function that is used to optimize the isotropy of the bending strengths. For another example, the metrics can include manufacturing parameters such as the cost of the panel.

The metrics are applied to an optimization function at a later step of the process. For example, the metrics such as bending strength metrics, can be applied to a cost function to optimize the isotropy of the bending strengths. For another example, the bending strength metrics can be applied to a standard deviation optimization function that is used to optimize the isotropy of the bending strengths. For yet another example, the bending strength metrics can be applied to a maximum optimization function that is used to optimize the minimum bending strength. The metrics and the optimization function are described at later steps of the process 122. Let it suffice to say here that the type of metrics and the type of optimization function are selected at step 124 in accordance with the particular requirements of the particular application in which the panel will be used.

In general, an infinite number of panel topology designs can be optimized to meet the design requirements determined at step 124. From among the infinite surface topologies available, some surface topologies may perform well for certain applications while others may not. Several particular panel designs have been analyzed that resulted from different starting design approaches. The random surface of FIG. 11 is but one such surface. Other illustrative panel topology designs will be shown in FIGS. 14-26.

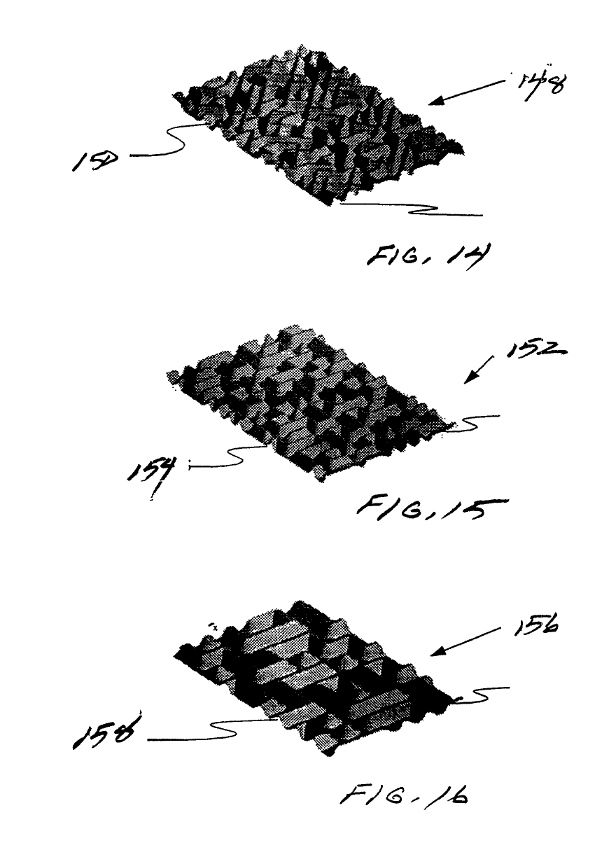

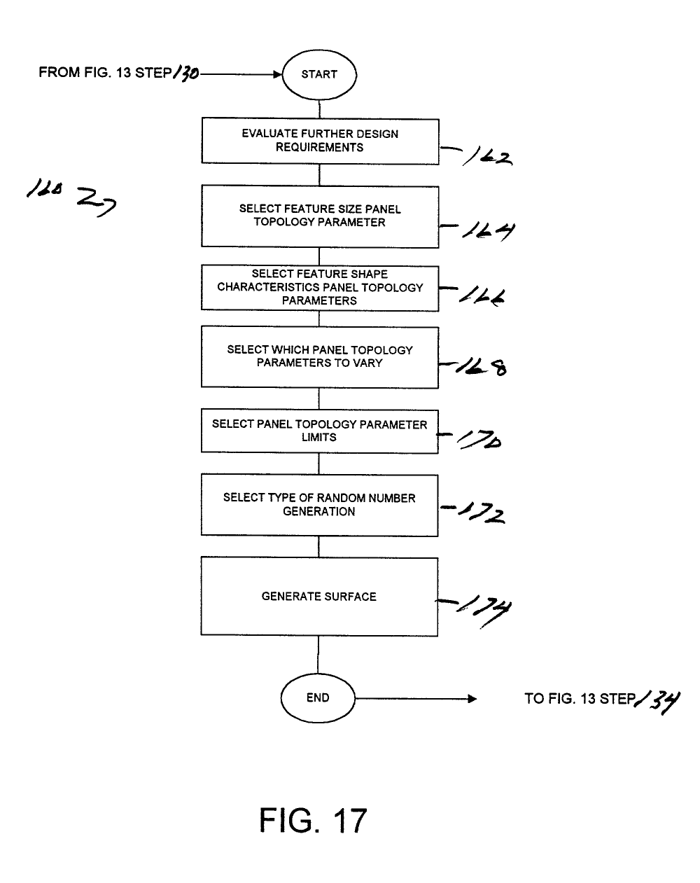

The designer next selects panel dimensions at step 126, panel material properties at step 128, and panel boundary conditions at step 130. The designer must then select a type of panel topology at step 132 from among the infinite possibilities of surface topologies, along with initial panel topology parameters that define the panel topology in detail. The selection of the type of panel topology is directed by many factors including the ease by which the resulting panel can be modeled or analyzed at step 134, the cost of producing such a surface, the material of the panel, the size of the panel, and the application of the panel. The specific panel topology parameters to be selected are associated with the specific type of panel topology from among many. The process of selecting panel topology parameters are further described in FIGS. 17, 21, 24, 27, and 31. Let us assume here that the random panel topology of FIG. 11 is selected, along with initial panel topology parameters associated with the random surface.

These characteristics of the panel selected at steps 126-130 are combined as input to a mechanical model of the panel at step 134 that is used to further provide an output that indicates the values of metrics of the type chosen at step 124. In general, the primary metric to consider for the panel with panel topology is the bending strength along the panel at multiple cross sections of the panel. A finite element model (FEM) used in finite element analysis, the method also generally referred to as FEM, is an illustrative example of a model that can be used to provide the bending strengths. It will be recognized that FEM is but one example of a modeling method that can be used to provide the bending strengths. Other modeling methods include mathematical empirical analysis, including use of the equation for cross-sectional second moment of inertia discussed below.

One measure of a panel's stiffness, assuming a homogeneous material, is the cross-sectional second moment of inertia for bending,

$$I = \frac{h}{L} {\int }_{0}^{L} ( {z}^{2} + \frac{{h}^{2}}{12} ) ⅆ l$$

where h is the thickness (assumed to be nearly constant for the instant panels), L is the length of the cross-section being analyzed, and z describes the panel topology of the panel. For a perfectly isotropic structure, the value for I is a constant regardless of the length and orientation of the cross-section along L. The above equation leads to the conclusion that the design goal for a panel with panel topology should be to move the material away from a neutral axis, where the neutral axis is that axis that passes through the center of the z, thickness dimension. With this equation one can evaluate the stiffness of cross sections of panels with various surface topologies.

It should be recognized, however, that the above equation assumes that bending occurs along straight lines. For a panel with panel topology, such as that indicated in FIG. 11, this assumption is only an approximation. The above equation, though convenient for flat panels and beams, fails to capture the physical possibility that bending may conform to a panel's shape along a “bending wave” rather than along a straight line, so as to minimize energy during bending. Bending waves typically conform around panel surface features such that the deformation in the raised portions of a panel is minimized. Never-the-less, let it suffice here to say that the equation for cross-sectional second moment of inertia for bending is another illustrative model that can be used to determine the bending strength at various cross sections of the panel with panel topology.

While both FEM and the equation for cross-sectional second moment of inertia for bending have been given as illustrative models associated with step 134 by panel metrics, and in particular the bending strength of the panel with panel topology, can be quantified, one of ordinary skill in the art will recognize that there are a variety of models and methods that can be used to quantify both the bending strength of a panel along the selected cross sections and other metrics that were selected at step 124.fs

In general, an infinite number of cross sections can used to compute bending strength at step 134. However, the number of cross sections to be used is limited by realistic constraints, including the processing time if a computer is used, or the computation time where a computer is not used. It has been found that realistic analysis resolutions can be provided for an illustrative panel that is 8 inches by 12 inches as follows. Edge point resolutions, or spacing between points along the panel edges, in the range of 0.1 to 0.01 inches provides a sufficient number of cross sections for subsequent analysis. A maximum number of cross sections is provided by cross sections that connect a boundary point along an edge with all boundary points on the other three edges. The range thus becomes 912,150,400 to 921,599,040,000 cross-sections, corresponding to 0.1 to 0.01 inch edge point resolution respectively. The number of cross sections analyzed can be effectively minimized by allowing only those cross sections that go from each edge to a different edge. The range thus becomes 159,600 to 15,996,000 cross-sections. The number of cross section can be further minimized by allowing only those cross sections that go from each edge to an opposite edge and that are parallel to an edge. The range thus becomes 200 to 2000 cross-sections. Though the above examples point out particular illustrative means by which the number of cross sections to be analyzed can be minimized, it will be recognized by one of ordinary skill in the art that there are a number of ways by which the number of cross sections can be minimized.

Proceeding to step 136, the designer applies the panel metrics, for example the bending strengths, along with other metrics of interest to an optimization function, where the optimization function was defined, as mentioned earlier, along with the design requirements at step 124. An illustrative optimization function that can be applied to the metrics is a cost function.

The cost function corresponds to a least squares method of optimization. The cost function can be of the following form:

$$c = \sqrt{{\sum }_{1}^{n} {W}_{i} \cdot {ξ}_{i}^{2}}$$

where C represents the cost function, ξᵢ is a quantifiable parameter, for example the bending strength, Wᵢ are weighting factors (the greater value of Wᵢ the more important the parameter), n is an integer representing the number of parameters to be considered, for example the number of bending strengths. It should be recognized that while, for the panel with panel topology, the ξᵢ of primary interest are the bending strengths along the various cross sections described above, other metrics can be included among the ξᵢ. For example the panel cost can be included with a specific weighting factor, Wᵢ. However, assuming that only the bending strengths are used, C is the square root of the sum of the squares of the bending strengths provided by the model at step 134.

It should be recognized that the above cost function is general and can be applied to any type of panel parameters, of which the bending strengths are but one type. Where bending strengths are applied to the cost function, it will be recognized that the cost function above can provide a measure of the isotropy of the bending strengths. Minimizing the cost function can provide a panel with generally isotropic bending strength among the cross sections analyzed. It should be further recognized that although the cost function is given as an illustrative example of an optimization function that can be optimized at step 142, other optimization functions can be used in place of or in addition to the cost function. Similarly, the other optimization functions can be combined in any way. For example, a standard deviation function is another optimization function that will provide a useful optimization result. One of ordinary skill in the art will recognize that a standard deviation function performed on the bending strengths, if minimized, will provide a generally isotropic bending strength among the cross sections analyzed. For yet another example, where the design requires not an isotropic behavior but instead a minimum bending strength among the cross sections analyzed, a maximize function that optimizes the minimum bending strength among the bending strengths is an optimization function that will provide a useful optimization result.

At step 138, the designer determines whether the optimization function results meet the design requirements established at step 124. If the optimization function results do not meet the design requirements, the designer, or alternatively an automated computer process, alters the panel topology parameters at step 142 and again proceeds at the modeling at step 134. If the optimization function results are found not to be converging at step 140 to a panel solution that meets the design requirements, then new design requirements must be established at step 124.

If the optimization function output does meet the design requirements, then the designer experimentally verifies the panel at step 144. Whereas the model behavior at step 134 is only an approximation, the actual panel may behave differently at step 144. If the panel experimentally meets the design requirements at step 146, the process is complete. If the panel does not experimentally meet the design requirements at step 146, optionally the panel is altered again at step 142 via step 140 and the panel is re-modeled at step 134. Alternatively, new design requirements must be established at step 124.

Where the design never converges at a sufficiently optimized performance at step 146, the designer must begin again at an earlier step. For example, the designer can provide a new panel topology with new panel topology parameters at step 126. For yet another example, the designer can return to the beginning of the process at step 124 and establish new design requirements.

Referring now to FIG. 14, an isometric view is shown of a panel surface 148 with another illustrative form of statistical panel topology corresponds to an illustrative maze panel topology 150. The surface 150 is constructed as a maze with two surface ridges, one with a minimum height, and one with a maximum height. Each type of ridge is provided having a statistical x-y direction in the x-y plane of the panel. Each ridge is provided having the same constant width.

Referring now to FIG. 15, an isometric view is shown of a panel surface 152 with yet another illustrative form of statistical panel topology corresponds to another illustrative maze panel topology 154. The surface 154 is constructed as a maze with two surface ridges, one with a minimum height, and one with a maximum height. Each type of ridge is provided having only a direction parallel to the x-y axes of the panel. Each ridge is provided having the same constant width. This panel surface is described by the same panel topology parameters as that of FIG. 14.

Referring now to FIG. 16, an isometric view is shown of a panel surface 156 with yet another illustrative form of statistical panel topology corresponding to yet another illustrative maze panel topology 158. The surface 158 is constructed as a maze with two surface ridges, one with a minimum height, and one with a maximum height. Each type of ridge is provided having only a direction parallel to the x-y axes of the panel. Each ridge is provided having the same constant width. This panel surface is again described by the same panel topology parameters as that of FIG. 14. When compared to the maze surface of FIG. 15, the ridges can be seen to each have greater width.

Where three illustrative maze designs have been shown in FIGS. 14-16, it should be recognized that a variety of maze designs are possible, over infinite ranges of ridge widths (including statistical), and ridge angular orientations.

Referring now to FIG. 17, a statistical method 160 for designing a panel provides initial panel topology parameters corresponding to a statistical panel topology. Illustrative statistical panel topologies include the random panel topology and the maze panel topology discussed above. At step 162, the designer reviews the design requirements established at step 124 of FIG. 13 and specifically evaluates the application to which the panel is to be applied. At step 162, the designer considers a variety of factors including but not limited to those mentioned above as well as the panel cost, the range of parameters over which the panel will be used, and the impact of failure modes.

In order to meet the design requirements, the designer selects panel topology parameters including a feature size at step 164 and a feature shape characteristics at step 166. In one illustrative embodiment of a random panel topology, the panel topology parameters can include a grid point resolution value corresponding to grid points on the surface of the panel, and a grid point height value. In one illustrative embodiment of a maze panel topology, the panel topology parameters correspond to ribs with any number of possible cross sections, including circular, rectangular, and triangular, and rib height, rib width, and rib direction. However, it should be recognized that there are various shapes that can be defined with the panel topology parameters.

At step 170, the designer selects from among the panel topology parameters, which parameters will be randomly varied to form the statistical panel topology. For example, the feature size can be varied, or the feature shape characteristics can be varied, or both can be varied. Since true random variation includes values that are unbounded, the designer must bound the variation of panel topology parameters with limits at step 170.

The designer selects a type of random number generation at step 172. For example, a pseudo-random number generator can be used. Using the random number generator and the panel topology parameters, the designer generates a panel having a statistical panel topology at step 174. It should be recognized that subsequent optimization of the statistical panel topology at steps 134-142 of FIG. 13 is provided by random variation of the selected panel topology parameters.

Referring now to FIG. 18, an isometric view is shown of a panel surface 176 with an illustrative two-dimensional sinusoid panel topology 178.

A two-dimensional sine series panel topology can be defined by the following generalized series equation:

$$z = {\sum }_{0}^{k} ( {\prod }_{0}^{{n}_{k}} ( {A}_{{n}_{k}} \cdot sin ( \frac{π}{{T}_{{n}_{k}}} \cdot x + {φ}_{{n}_{k}} ) ) \cdot {\prod }_{0}^{{m}_{k}} ( {A}_{{m}_{k}} \cdot sin ( \frac{π}{{T}_{{m}_{k}}} \cdot y + {φ}_{{m}_{k}} ) ) )$$

$$x = a -> b , y = c -> d , z = g -> h ,$$

where x, y, z represent the spatial coordinates, A represents the amplitude of the sine, T represents the period, φ represents the phase, n represents the number of products in the x direction, m represents the number of products in they direction, and k represents the length of the series. The terms a, b, are the panel bounds in the x direction c, d, are the panel bounds in they direction, and g, and h represent the boundaries of the surface in the z direction. All of the variables above correspond to panel topology parameters to the two-dimensional sinusoid panel topology.

In one particular example, a panel is provided having a width of 8 inches, a length of 12 inches and a panel topology defined by the equation:

z=½[sin(πx+π/2)sin(πy)+sin(πy+π/2)+sin(πx)].

It will be recognized by one of ordinary skill in the art that any two-dimensional panel topology can be approximated by a two-dimensional sine series. The formula above allows for a common set of panel topology parameters (i.e. amplitude, period, and phase) for a variety of surface topologies, including, but not limited to, surface topologies that appear sinusoidal.

Though all of the variables, or panel topology parameters, of the above equation can be used in an optimization function (steps 134-142 of FIG. 13) it may be desirable to limit the number of such parameters that are altered during the optimization process (step 142 of FIG. 13). Computer optimizations have successfully used three series in the above generalized series equation, each with different parameters, amplitude, period and phase, to provide optimization of a cost function described above (step 136-138 of FIG. 13).

Referring now to FIG. 19, an isometric view is shown of a panel surface 180 with another illustrative two-dimensional sinusoid panel topology 182. The sinusoid panel topology parameters, amplitude, period, and phase, associated with the two-dimensional sinusoid equation above were altered from those of FIG. 18 to provide the illustrative surface 182.

Referring now to FIG. 20, an isometric view is shown of a panel surface 184 with yet another illustrative two-dimensional sinusoid panel topology 186. The sinusoid panel topology parameters amplitude, period, and phase, associated with the two-dimensional sinusoid equation above were altered from those of FIGS. 17 and 18 to provide the illustrative surface 186.

It should be recognized that the illustrative two-dimensional sinusoidal surface topologies 178, 182, 186 of FIGS. 18-20 are but three of a variety of sinusoidal surface topologies that can be defined with the sinusoid panel topology parameters of the above equation.

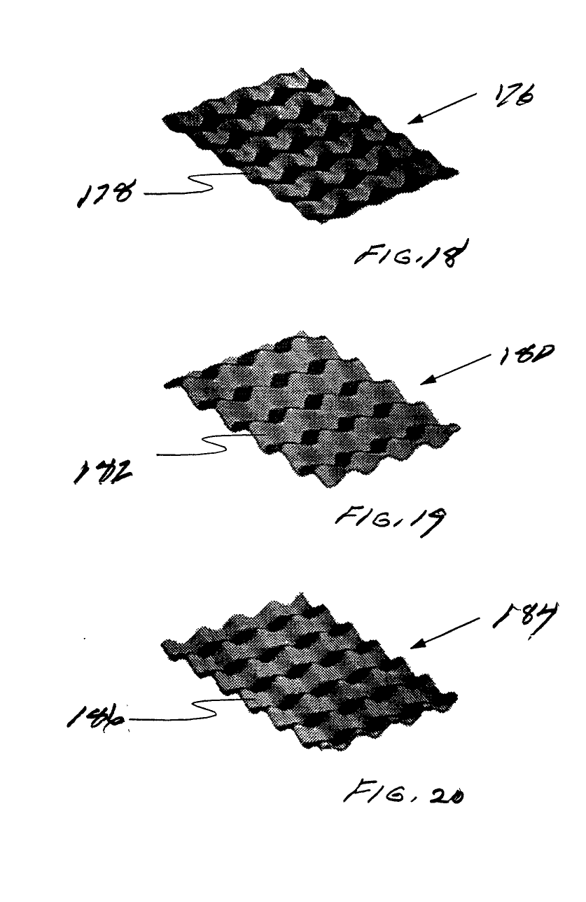

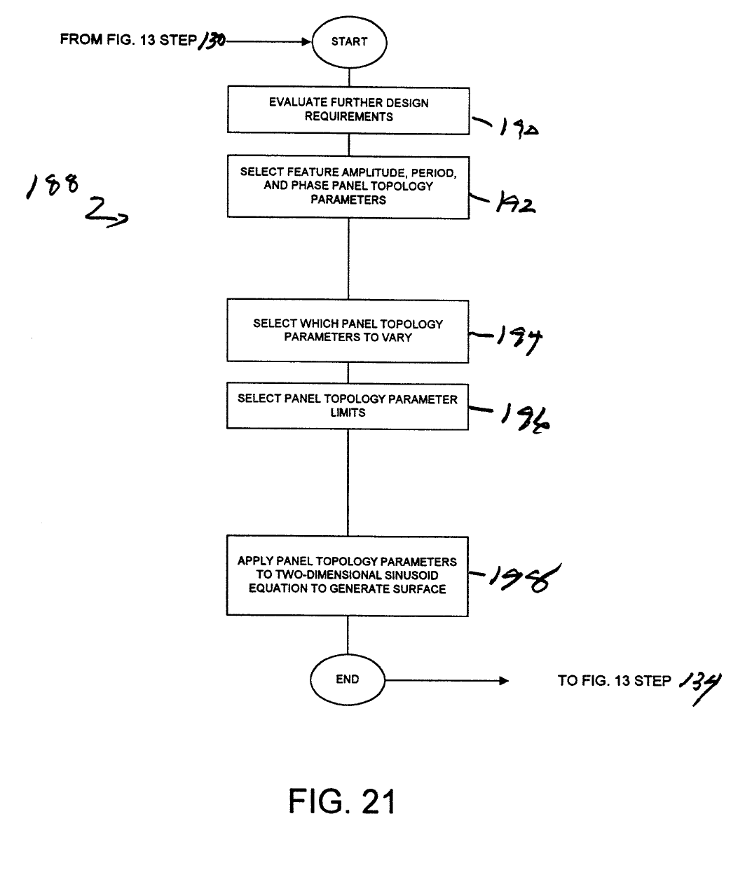

Referring now to FIG. 21, a method for providing a panel providing a panel having an initial panel topology corresponding to a two-dimensional sinusoid panel topology begins at step 190, design requirements established at step 124 of FIG. 13 are reviewed and evaluated with respect to the application to which the panel is to be applied. At step 190, additional factors including but not limited to the panel cost, the range of parameters over which the panel will be used, and the impact of failure modes are considered.

In order to meet the design requirements, selected panel topology parameters including feature amplitude, phase, and period at step 192, in accordance with the two-dimensional sinusoid equation. Panel topology parameters are set to vary at step 194 and limits on those parameters are set at step 196. The the two-dimensional sinusoid equation and the associated panel topology parameters are used at step 198 to generate an initial panel topology.

Referring now to FIG. 22, a shape 200 defined by six ellipses 202a-202f is shown where the shape can be used to define an illustrative shape based panel topology as shown in FIG. 23. The six ellipse shape 200 represents some of the panel topology parameters that can be altered to effect the elliptical panel topology during the optimization process (steps 134-142 of FIG. 13) including the major radii R1, R2, R3 and the minor radii r1, r2, and r3. When placed on the surface of a panel, other panel topology parameters include the height of the shape and the orientation of the shape.

It should be recognized that the six ellipse shape is but one of a variety of shapes that could be used to subsequently define a shape based panel topology for example the surface shown in FIG. 23. Other illustrative shapes include rectangles, trapezoids, octagons, or combinations thereof.

Referring now to FIG. 23, an isometric view is shown of a panel surface 208 with an illustrative shape based panel topology 210 corresponding to an illustrative elliptical panel topology for which the panel topology is defined by the elliptical panel topology parameters described above. The illustrative panel elliptical panel topology 210 is provided by placement of the elliptical shapes of FIG. 22 on the panel surface 208, where the elliptical shape 200 (FIG. 22) is shown in top view with respect to the panel surface 208.

It should be recognized that the illustrative elliptical panel topology 210 is but one of a variety of elliptical surface topologies that can be defined with the elliptical panel topology parameters. It should further be recognized that other illustrative shape panel topologies include rectangle, trapezoid, and octagon panel topologies, or combinations thereof.

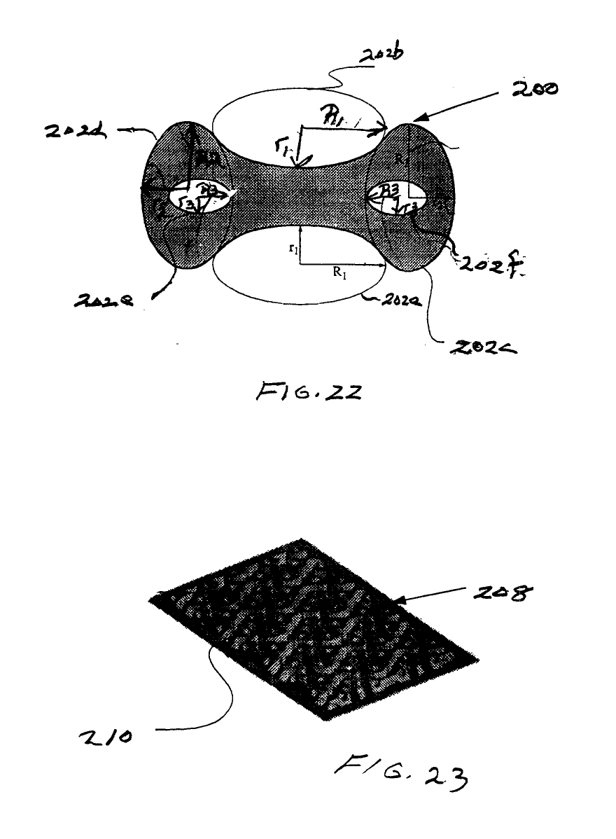

Referring now to FIG. 24, a method 210 for providing a panel having initial panel topology parameters corresponding to a shape based panel topology begins at step 210 in which the design requirements established at step 124 of FIG. 13 are reviewed and the application to which the panel is to be applied is evaluated. At step 210, additional factors to be considered including but not limited to the panel cost, the range of parameters over which the panel will be used, and the impact of failure modes are reviewed.

In order to meet the design requirements, selected panel topology parameters including a feature size at step 212 and a feature shape characteristics at step 214 are selected. In one illustrative embodiment, the feature shape characteristic can describe the ellipse shape of FIG. 22 for which the panel topology parameters were described above. However, it should be recognized that there are a variety of shapes that can be defined with the panel topology parameters.

At step 216, panel topology parameters to use during an optimization process, which parameters will be varied to form the shape based panel topology are considered. It should be recognized that subsequent optimization of the shape based panel topology at steps 134-142 of FIG. 13 is provided by a selection of panel topology parameters that provides an optimization. At step 218, the limits are set on the panel topology parameters.

At step 220, shape based panel topology parameters are used to generate a panel having an initial shape based panel topology. The shape pattern is repeated on the surface of the panel in various patterns and with various shape characteristics, including height from the surface of the panel.

Referring now to FIG. 25, an top view is shown of an individual tile 222 that includes individual tile grid points 224, each of which can be at a different height as indicated by the darkness of the points.

The tile 222 provides a tile with a shape, for example square, as defined by a first tile panel topology parameters and with a tile area that is some fraction of the panel total area as defined by second tile panel topology parameters. A resolution, or size, of the tile grid points 224, and a tile grid point height 224 are third and fourth tile panel topology parameters. The four tile panel topology parameters can be altered (step 142 of FIG. 13) to optimize an optimization function (step 136 of FIG. 13). It has been found that holding the first, second, and third tile panel topology parameters constant across all of the tiles, and varying only the fourth, tile height, panel topology parameter between a minimum height value and a maximum height value provides an effective optimization of the cost function at FIG. 13 step 136. However, it should be recognized that the tile panel topology parameters can individually be altered from tile to tile or alternatively they can each be altered across all of the tiles. It should be further recognized that where the illustrative embodiment shows only square tiles, the tiles can be of any interconnecting shape. For example, the tiles could be diamond shaped.

The complexity of the optimization can be controlled both by the size of the square and the resolution of the square. The larger the square and the greater the resolution of points defining the square the more complex the optimization, and the less likely the optimization will converge.

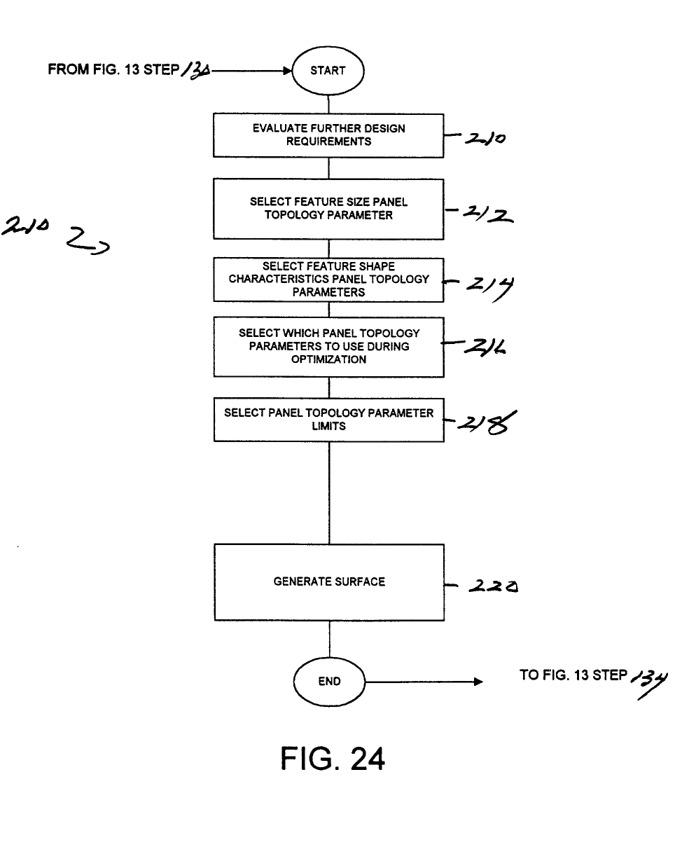

Referring now to FIG. 26, an isometric view is shown of the panel surface 226 of the illustrative tile panel topology 228 of FIG. 25.

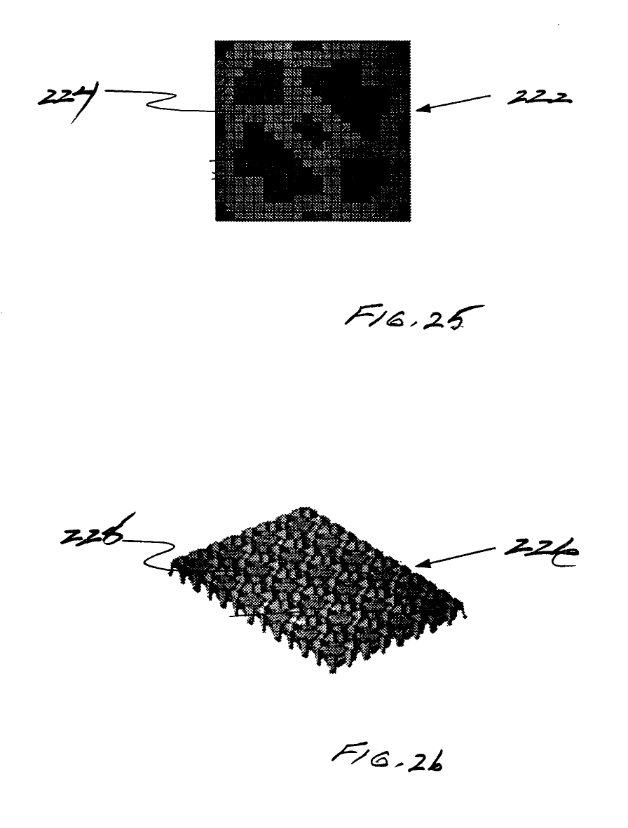

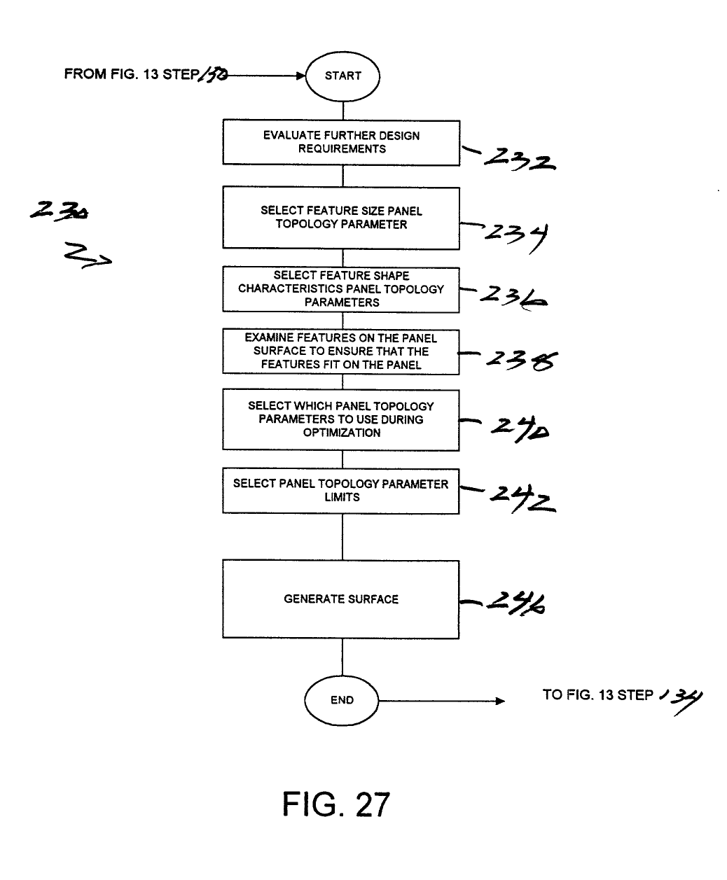

Referring now to FIG. 27, a method 230 for providing a panel having initial panel topology parameters corresponding to a tile panel topology begins with step 232, in which the design requirements established at step 124 of FIG. 13 are reviewed and the application to which the panel is to be applied is evaluated. At step 232, additional factors including but not limited to such as the panel cost, the range of parameters over which the panel will be used, and the impact of failure modes are considered.

In order to meet the design requirements, a basic feature size at step 234 and a basic feature shape at step 236 are selected, with a grid point resolution and grid point height as described above. For example, the designer may select a square tile or an octagonal tile shape. At step 238, an examination of the tile integration onto the panel surface to ensure that the tiles provide the required panel shape is made.

At step 240, a selection is made from among the tile panel topology parameters, which parameters will be varied to form the tile panel topology. It should be recognized that subsequent optimization of the tile panel topology at steps 134-142 of FIG. 13 is provided by a selection of panel topology parameters that provides an optimization. At step 242, limitations are set on the panel topology parameters.

The designer uses the tile panel topology parameters to generate a panel at step 246 having a tile panel topology. Tiles, of which tile 222 (FIG. 25) is but one illustrative example, are placed on the surface of the panel.

Referring now to FIG. 28, an isometric view is shown of a panel surface 248 with an illustrative two-dimensional corrugated panel topology provided by an illustrative concentric circle panel topology 250.

Complex shapes such as the concentric circle design 250 can be formed by embedding the generic two-dimensionally curved shape equation within a sinusoid as indicated in the following equation:

z=sin(fn(x, y))

where the function of x and y is the generic function for a two-dimensional curvature given earlier. If one wanted to create concentric circular ribs then the panel surface would be defined by:

z=A sin((x−cₓ)²+(y−c_{y})²−r²)

where A is the amplitude of the ribs, r represents the radius of the initial repeated circle, and cₓ and c_{y} determine where the center at which the concentric circles lie. Any or all of these variable, corresponding to panel topology parameters, can be altered (FIG. 13 step 142) to optimize a panel design. The panel surface 248 is but one illustrative surface of the type described by the equation above. It will be recognized that, like the other panel surfaces above, there are an infinite number of concentric circle surface topologies.

Though vibration has not been discussed as a metric by which panels with panel topology are judged, it should be noted that the concentric circle design does very little to stiffen the first mode of vibration because the bending lines during the first mode are often nearly circular.

Referring now to FIG. 29, an isometric view is shown of another panel 252 with a two-dimensional corrugated panel topology provided by a panel surface 254 with an illustrative flower petal panel topology.

Like the concentric circle design above, complex shapes such as the flower petal design 254 can be formed by embedding the generic two-dimensionally curved shape equation within a sinusoid. The flower petal panel topology can be defined by the following equation:

$$z = A \cdot sin \{ {( x - {c}_{x} )}^{2} + {( y - {c}_{y} )}^{2} - {( sin ( {n}_{l} \cdot a tan ( \frac{{( y - {c}_{y} )}^{2}}{{( x - {c}_{x} )}^{2}} ) ) )}^{2} - 2 r \cdot sin ( ( {n}_{l} \cdot a tan ( \frac{{( y - {c}_{y} )}^{2}}{{( x - {c}_{x} )}^{2}} ) ) - {r}^{2} ) \}$$

where nₗ is a panel topology parameter that represents the number of lobes or petals in the flower shape, cₓ and c_{y} represent the location of the center of the petals, and r represents the radius of the primary corrugation from which all others radiate. This panel eliminates the circular bending lines of the concentric circle panel topology, however, there still exists several areas where the flower petal design exhibits bending compliance, especially near the corners and edges. In addition, this shape is quite complex and would likely be difficult to manufacture.

Any or all of variables, corresponding to panel topology parameters, can be altered (FIG. 13 step 142) to optimize the flower petal panel topology panel design. The panel flower petal surface 254 is but one illustrative surface of the type described by the equation above. It will be recognized that, like the other panels surfaces above, there are a variety of flower petal surface topologies.

Referring now to FIG. 30, an isometric view is shown of yet another panel 256 with a two-dimensional corrugated panel topology provided by a panel surface 258 with an illustrative zigzag panel topology.

A zigzag panel topology can be defined by the following equation:

$$z = {A}_{z} \cdot sin ( y - ( {A}_{z} \cdot sin ( \frac{π}{{T}_{z}} \cdot x ) ) )$$

where A_{z} is the amplitude of the sinusoidal zigzag pattern in the x-y plane, and T_{z} is the wavelength of the zigzag design, and all of which are panel topology parameters that can be altered (FIG. 13 step 142) to optimize the panel design. The effectiveness of this design is based primarily on the ratio of the amplitude, A_{z}, to the wavelength, T_{z}.

Any or all of these variables, corresponding to panel topology parameters, can be altered (FIG. 13 step 142) to optimize the zigzag panel topology panel design. The panel surface 258 is but one illustrative surface of the zigzag type described by the equation above. It will be recognized that, like the other panel surfaces above, there are a variety of zigzag surface topologies.

However, the repeatability of the illustrative zigzag shape indicated in FIG. 30 limits its effectiveness as an isotropic shape. The repeated troughs and valleys line up along diagonals and lead to much more compliant regions, and the panel appears to bend along the folds leading to a highly orthotropic panel. However, modifications to the panel topology parameters associated with the zigzag panel topology can lead to an optimized zigzag panel topology for which results as shown in FIGS. 27 and 28.

Other panels with two-dimensional surface topologies that can be optimized analytically include panels with fractal patterns and Penrose based tiling patterns.

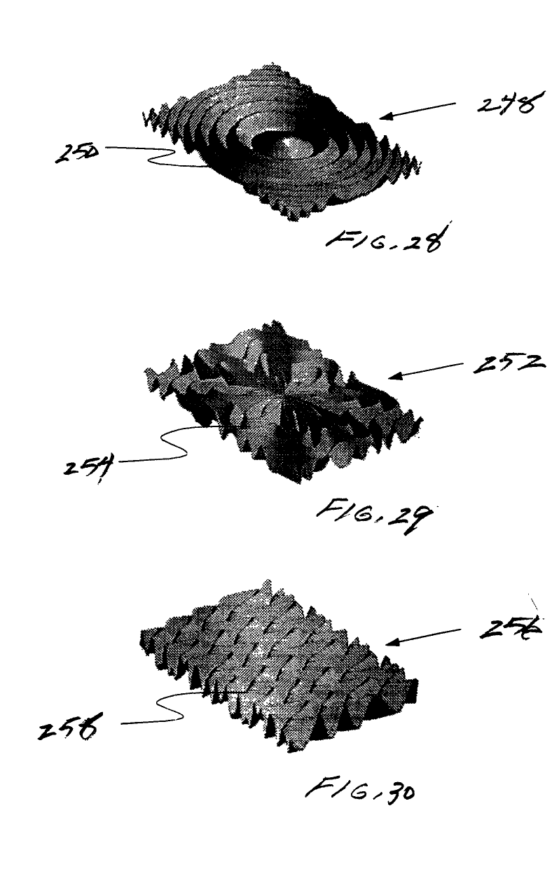

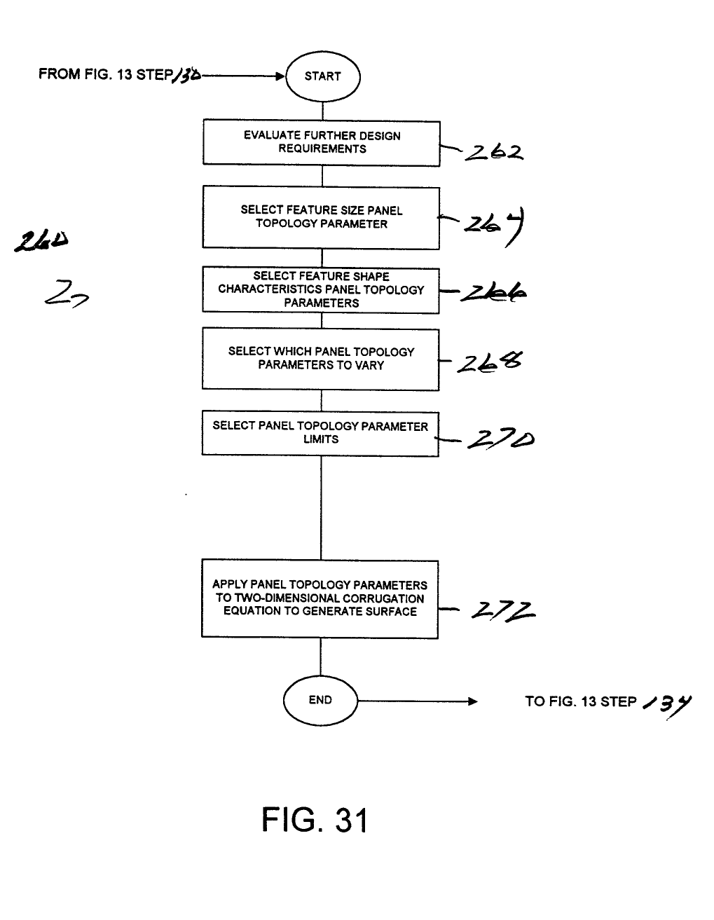

Referring now to FIG. 31, a method for providing a panel having initial panel topology parameters corresponding to a two-dimensional corrugated panel topology begins with step 262 the design requirements established at step 124 of FIG. 13 are reviewed and the application to which the panel is to be applied is evaluated. At step 262, additional factors, including but not limited to, the panel cost, the range of parameters over which the panel will be used, and the impact of failure modes are considered.

In order to meet the design requirements, panel topology parameters including a basic feature size at step 264 and a basic feature shape at step 266 are selected. For example, a shape such as a concentric circle shape, a flower petal shape or a zigzag shape may be chosen. The respective panel topology parameters were discussed above in association with FIGS. 28, 29, and 30 respectively.

At step 268, a selection is made from among the panel topology parameters, which parameters will be varied to form the two-dimensional corrugated panel topology. It should be recognized that recognized that subsequent optimization of the two-dimensional corrugated panel topology at steps 134-142 of FIG. 13 is provided by a selection of panel topology parameters that provide an optimization. At step 270, limitations on the panel topology parameters are set.

In step 272, the designer uses the two-dimensional corrugation equation and the associated panel topology parameters are used to generate a panel having an initial two-dimensional corrugated panel topology.

Referring now to FIGS. 32 and 33, graphs are shown in which the cross section is shown along the x axis and the cross-sectional moment area of inertia is shown on the y axis for four panels.

Each of the four panels has a different panel topology with a normalized amplitude of ten and each were optimized as through the process 122 of FIG. 13. Curves 274a-274b for a panel with a maze panel topology, curves 276a-276b for a panel with a two-dimensional sine panel topology, curves 278a-278b for a tile panel topology, and curves 280a-280b for a zigzag panel topology are shown. Remembering the earlier discussion corresponding to FIG. 13 concerning the minimization of cross sections, it can be seen that this is a panel with width and length dimensions of eight inches and twelve inches respectively and the edge point resolution is 0.1 inches. Only cross sections parallel to an edge are used. Thus, there are a total of two hundred cross sections, eighty in width and one hundred twenty in length, for a total of two hundred. An FEM method was used to provide the curves of FIGS. 32 and 33. The panel edges were simply supported.

It can bee seen that the optimized zigzag pattern has been predicted to have the most likely isotropic behavior amongst the cross sections. It should be recognized, however, that modeled results, such as those indicated, can differ from actual panel performance. In particular, the model assumes that bending occurs along straight lines, which may not be the case. It should be further recognized that a panel with no panel topology, if represented on these graphs, would provide a line near zero on the y axis. Thus, all of the panels are indicated to provide a bending strength greater than a panel without panel topology.

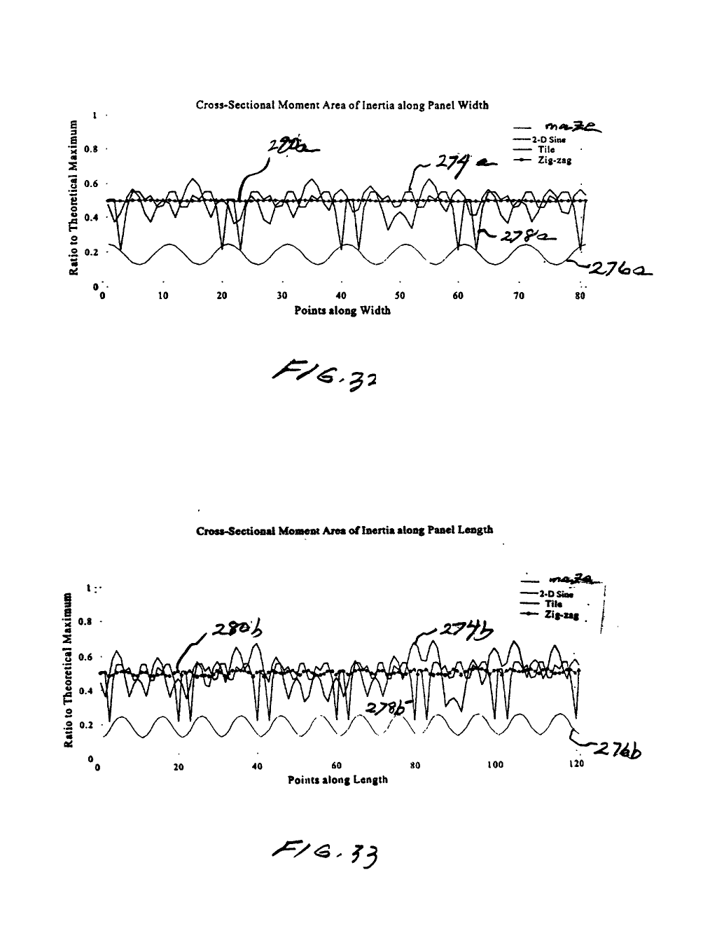

Referring now to FIG. 34-37, graphs are shown in three dimensional view in which the x and y axes represent the panel length and width respectively and the cross-sectional moment area of inertia is shown on the z axis for four panels. Each of the four panels has a different panel topology and each were optimized as through the process 122 of FIG. 13. A graph 282 for a panel with a two-dimensional sine panel topology, a graph 284 for a panel with a tile panel topology, a graph 286 for a maze panel topology, and a graph 288 for a zigzag panel topology are shown. The panels have the same dimensions described in association with FIGS. 27 and 28, the same edge point resolution and again an FEM method was used. However, unlike the curves of FIGS. 27 and 28, the number of cross sections has not been limited only to those that are parallel to the edges of the panel. Again, a panel with a zigzag panel topology can be seen to have the most isotropic bending strength, as indicated by the most flat graph 288.

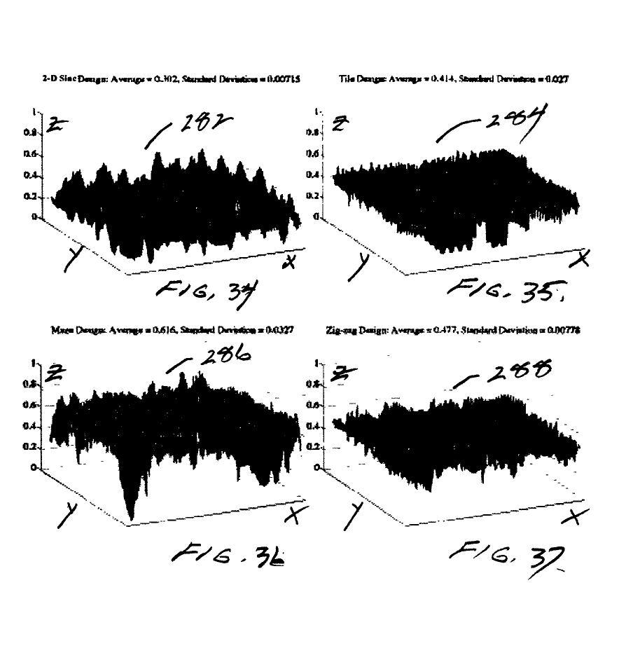

Referring now to FIG. 38 in comparison with FIG. 8, FEM vibration characteristics are shown for a panel with two-dimensional sine panel topology. The normalized amplitude of the panel, or equivalently the normalized peak to trough value, is indicated along the x axis, while a normalized frequency is indicated along the y axis. The normalized frequency is the frequency of a particular natural mode of vibration in the mode-shaped panel, for example mode one, divided by the frequency of the first mode of vibration if the panel were flat. Looking at the curve 292 representing the first mode of vibration of the mode-shaped panel, one can see that its intersection 290 with the y axis is at 1. This intersection is as expected since at this point, the normalized amplitude of the panel mode shape is zero, thus the panel is flat, and the frequency of its first mode of vibration will be that of a flat panel. Each curve 292-306 represents a change in the frequency of a particular respective mode of vibration, therein are shown modes one through eight, as the normalized amplitude of the panel shape is increased.

Again referring to the curve 292 that represents the first mode of vibration of the first mode-shaped panel, it can be seen that a normalized amplitude of fifteen, represented by data point 308, provides a normalized frequency of vibration of the first mode that is approximately three times that of the first mode if it were a flat panel, represented by data point 290. This data point can be compared to data point 98 of FIG. 8, where a mode-shaped panel with the same normalized amplitude of fifteen has provided a normalized frequency of vibration of the first mode that is nearly seven times that of the first mode if it were a flat panel. Thus, though the panel topology provides an increase in the frequencies of vibration of the various modes of vibration compared to a flat panel, it has less of an effect than the mode-shaped panel. The mode-shaped panel is superior at reducing particular modes of vibrations.

Never the less, a panel with panel topology can be seen to provide a substantial effect on the frequency of vibration of the various modes. It should be obvious to one of ordinary skill in the art that any panel topology can combined with any mode shape to provide both improved vibrational damping from the mode shape and improved bending strength and bending strength isotropy from the panel topology. The design methods shown in FIG. 7 for the mode-shaped panel, and in FIG. 13 for panel with panel topology can be used independently or combined to provide a panel that is optimized for a particular vibrational and bending strength design requirement.

Referring now to FIG. 39, a multi-layered panel structure 310 is provided having a two-dimensionally curved panel portion 312 and a flat layer portion 314. Such a multi-layered panel structure may be desirable in certain applications, for example for a panel used as a washing machine enclosure where aesthetic appearance would be improved with a flat layer portion 314. It should be recognized by one of ordinary skill in the are that either a panel with panel topology, a mode-shaped panel, or a panel with both panel topology and a mode shape can be provided as the two-dimensionally curved panel portion 312 of the multi-layered panel structure 310, or as the two-dimensionally curved panel portion of any of the multi-layered panel structures hereafter described.

The multi-layered panel structure provides not only greater aesthetic appeal than a single layer two-dimensionally curved panel in some applications, but also provides greater rigidity and impact absorption qualities.

The multi-layered panel structure has advantages over a conventional honeycomb design. The manufacturing methods for the multi-layered panel structure include rolling, stamping, vacuum forming, and injection molding, whereas the manufacturing methods for conventional the honeycomb panel include extrusion. Whereas extrusion is known to be an expensive manufacturing process, the multi-layered panel structure should be less expensive than the honeycomb panel.

The primary design goals of the two-dimensionally curved panel portion of the multi-layered panel structure are to maintain a nearly constant normalized amplitude over the panel surface, minimize shear, and to provide either bending strength isotropy or a desired non-isotropy. The nearly constant normalized amplitude provides contact points 316 to which the flat layer portion 314 can be bonded, for example with glue.

It is expected that the performance in bending of the multi-layered panel structure 310 is improved from that of the two-dimensionally curved panel portion 312 alone. The bending line that would tend to conform around curved surface features of the two-dimensionally curved panel portion 312 alone, will be held to a straighter by the flat layer portion 314.

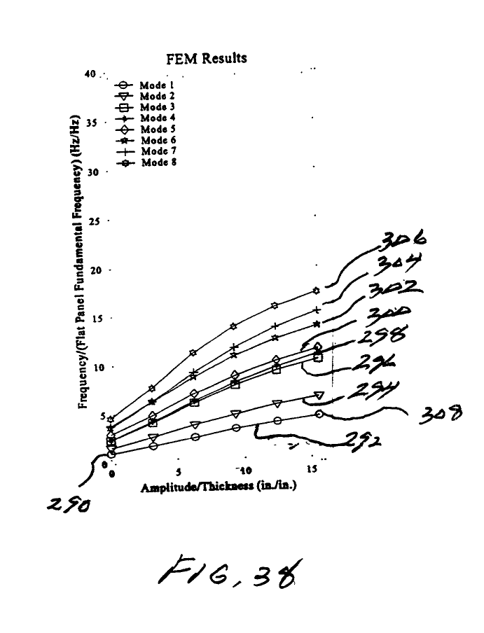

Referring now to FIG. 40, a multi-layered panel structure 318 is provided having a two-dimensionally curved panel portion 320 and two flat layer portions 322, 324. Such a multi-layered panel structure may be desirable in certain other applications, for example for a panel used as an athletic helmet structure where the outer smooth surface, for example the surface of flat panel portion 322, will provide an improved aesthetic appearance, and an inner smooth surface, for example the surface of flat panel portion 324, would provide an improved wearing comfort.

Referring now to FIG. 41, a multi-layered panel structure 326 is provided having a two-dimensionally curved panel portion 328, two flat layer portions 330, 332, and two damping layer portions 334, 336. Such a multi-layered panel structure may be desirable in yet certain other applications, for example for a wall panel design where improved acoustic damping performance is required. The damping layer portions can be either acoustic absorption material, or viscous damping material. For example foams, muffler layers, and porous rubbers can be used for acoustic applications, and visco-elastic rubber can be used for vibration applications.

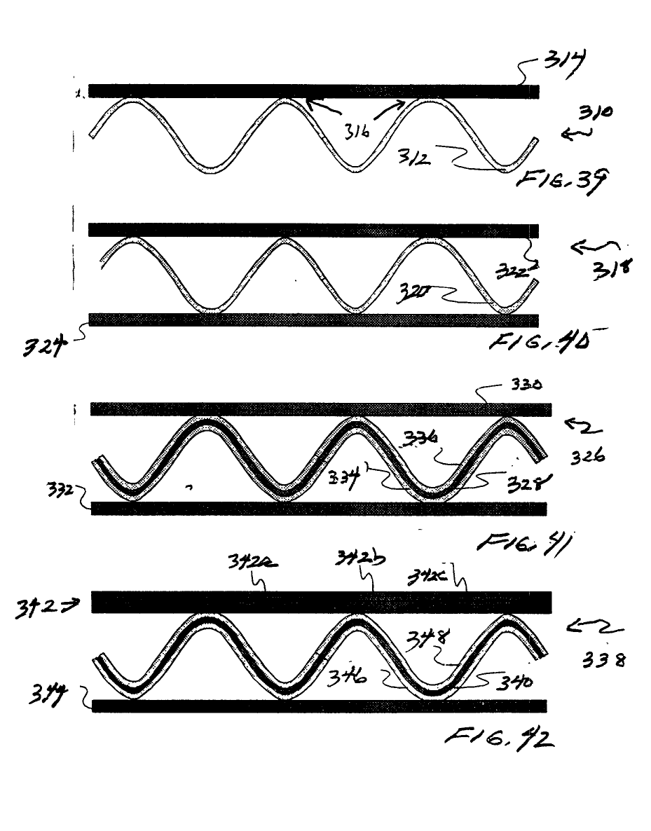

Referring now to FIG. 42, a multi-layered panel structure 338 is provided having a two-dimensionally curved panel portion 340, two flat layer portions 342, 344, one or each of which has flat multi-layer panel portions 342a-342c, and two damping layer portions 346, 348. Having multiple damping layers, respective ones of the damping layers can be made of different materials. For example a first layer can provide acoustic absorption, and a second layer can provide vibration damping.

Referring now to FIG. 43, a multi-layered panel structure 350 is provided having a two-dimensionally curved panel portion 352, a flat layer portion 354, a damping layer portion 356, and a constrained damping layer portion 358. As with the damping layer portion 356, the constrained damping layer portion 358 can be either acoustic absorption material, or viscous damping material. Such a multi-layered panel structure may be desirable in yet certain other applications, for example for a wall panel design where substantial acoustic damping performance is required.

It is known by one of ordinary skill in the art that constrained damping layers within conventional multi-layered panels designs have been shown to be very effective for controlling vibration an acoustic transmission. It is believed that when constrained damping layers, for example constrained damping layer portion 358 is combined within the multi-layered panel structure, for example the multi-layered panel structure 350, greater damping can be achieved.

Increased damping of vibration and acoustic transmission is provided in part because some of the damping material of constrained damping layer portion 358 is moved away from the neutral axis 360 of the two-dimensionally curved panel portion 352, where it will undergo greater extensional and compressional deformation. If the majority of this deformation is in the plane of the damping material, then a greater degree of deformation, or viscous flow, may occur than if the material is in shear at the neutral axis. Also, the two-dimensional curvature of the surface of the constrained damping layer portion 358 will lead to multi-directional deformation of the constrained damping layer portion 358. Again, the multi-directional flow or deformation can lead to greater damping.

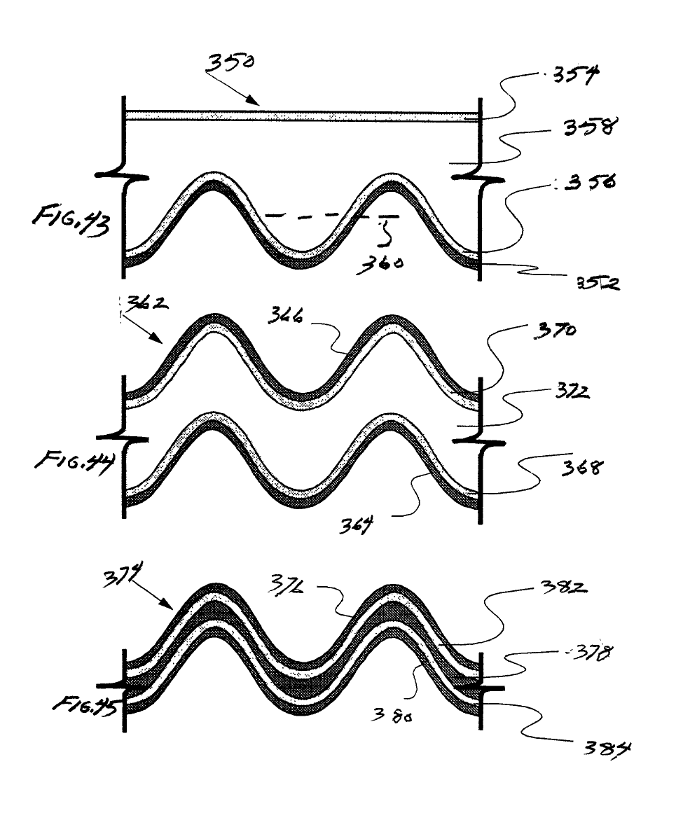

Referring now to FIG. 44, a multi-layered panel structure 362 is provided having two two-dimensionally curved panel portions 364, 366, two damping layer portions 368, 370 and a constrained damping layer portion 372. Such a multi-layered panel structure may be desirable in yet certain other applications, for example for a wall panel design where substantial acoustic damping performance and substantial bending strength is required.

Referring now to FIG. 45, a multi-layered panel structure 374 is provided having three two-dimensionally curved panel portions 376, 378, 380, and two damping layer portions 382, 384. Such a multi-layered panel structure may be desirable in yet certain other applications, for example for a wall panel design where more substantial bending strength is required.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A panel having a two-dimensional shape defined by an intersecting plane, a surface of the panel, and a nominal plane, wherein the nominal plane comprises a plane passing through a surface point of said panel and is generally orthogonal to a principal loading direction of said panel at said surface point, wherein said intersecting plane comprises a plane generally orthogonal to said nominal plane, and wherein an intersection of said intersecting plane with the surface of said panel comprises a line having a peak to trough value which is not equal to zero.

2. The panel of claim 1, wherein the peak to trough value is between 2 and 100 times the thickness of the panel at the surface point.

3. The panel of claim 1 having a panel topology.

4. The panel of claim 3, wherein the panel topology is selected from the group consisting of a statistical panel topology, a two-dimensional sinusoid panel topology, a shape based panel topology, a tile panel topology, and a two-dimensional corrugated panel topology.

5. The panel of claim 4, wherein the statistical panel topology is selected from the group consisting of a random panel topology and a maze panel topology.

6. The panel of claim 4, wherein the shape based panel topology is an elliptical panel topology.

7. The panel of claim 4, wherein the two-dimensional corrugated panel topology is selected from the group consisting of a concentric circle panel topology, a flower petal panel topology, and a zigzag panel topology.

8. The panel of claim 1 having a mode shape.

9. The panel of claim 5, wherein the mode shape corresponds to the shape of a mode of vibration of a corresponding un-deformed panel.

10. The panel of claim 8, wherein the mode shape corresponds to the shape of the first mode of vibration of the corresponding un-deformed panel.

11. The panel of claim 1, further comprising a plurality of layers.

12. The panel of claim 11, wherein respective ones of the plurality of layers are provided from at least 2 different materials.

13. The panel of claim 11, wherein at least one layer of the plurality of layers is generally flat.

14. The panel of claim 11, wherein at least one layer of the plurality of layers is a damping layer.

15. The panel of claim 11, wherein the at least one layer is an acoustic absorption material.

16. The panel of claim 11, wherein the at least one layer is a viscous damping material.

17. The panel of claim 11, wherein the at least one layer is a constrained damping layer.

18. A method of designing a panel with first and second surfaces and having a panel topology that provides a pre-determined behavior, comprising:
generating a panel having a two-dimensional shape defined by an intersecting plane, a panel surface of said panel, and a nominal plane, wherein said nominal plane comprises a plane passing through a surface point of said panel and is generally orthogonal to a principal loading direction of said panel at said surface point, wherein said intersecting plane comprises a plane generally orthogonal to said nominal plane, and wherein an intersection of said intersecting plane with said panel surface comprises a line having a peak to trough value;
defining the panel surface with panel topology parameters; and
analyzing the panel to provide panel metrics.

19. The method of claim 18, wherein the pre-determined behavior is a pre-determined bending strength behavior.

20. The method of claim 19, wherein the pre-determined bending strength behavior is a pre-determined isotropy of bending strength at a plurality of cross section of the panel.
